(19) United States
(12) Patent Application Publication
(10) Pub. No.: US 2013/0204700 A1
(43) Pub. Date: Aug. 8, 2013

(54) SYSTEM, METHOD AND COMPUTER PROGRAM PRODUCT FOR PREDICTION BASED ON USER INTERACTIONS HISTORY

(71) Applicant: Kenshoo Ltd., Tel Aviv (IL)

(72) Inventors: Joseph SYNETT, Tel Aviv (IL); Arriel Johan BENIS, Gan Yavne (IL); Gilad ARMON-KEST, Amirim (IL); Moti MEIR, Modi'in (IL); Roy DAVID, Kfar Saba (IL); Dorit ZILBERBRAND, Gvit Shmuel (IL); Jacob H. OAKNIN, Bat Hefer (IL)

(73) Assignee: KENSHOO LTD., Tel Aviv (IL)

(21) Appl. No.: 13/692,071

(22) Filed: Dec. 3, 2012

Related U.S. Application Data
(60) Provisional application No. 61/595,241, filed on Feb. 6, 2012.

(51) Int. Cl. G06N 5/02

(52) U.S. Cl. CPC G06N 5/02
USPC 705/14.53; 706/46; 705/14.69

(57) ABSTRACT

A system operable to computing a performance assessment, the system including: an interface, configured to obtain information of interactions which are included in a series of interactions, wherein at least one of the interactions of the series includes communication of digital media over a network connection; and a processor on which a performance assessment module is implemented, the performance assessment module is configured to compute a performance assessment for the series of interactions, based on the obtained information and on an assessment scheme which is based on a statistical analysis of historical data of a plurality of series of interactions.

### RELATED APPLICATIONS

This application claims priority from U.S. provisional patent application Ser. No. 61/595,241 filing date Feb. 6, 2012 and entitled “SYSTEM, METHOD AND COMPUTER PROGRAM PRODUCT FOR ATTRIBUTING A VALUE ASSOCIATED WITH A SERIES OF USER INTERACTIONS TO INDIVIDUAL INTERACTIONS IN THE SERIES”, which is incorporated herein by reference in its entirety.

### FIELD OF THE INVENTION

This invention relates to performance assessment based systems, methods and computer program products for prediction based on user interactions history.

### BACKGROUND OF THE INVENTION

U.S. Pat. No. 7,983,948 entitled “Systems and methods for electronic marketing” discloses an exemplary system which includes a publisher subsystem configured to communicate with an access device and an advertiser device over a data communication network. The publisher subsystem includes a publish module, a session module, and an allocation module. The publish module is configured to publish content over the data communication network, the content including an advertisement. The session module is configured to detect a selection of the advertisement, initiate a session between the access device and the advertiser device in response to the selection, the advertiser device being associated with the advertisement, and receive feedback from the advertiser device. The allocation module is configured to allocate revenue based on the feedback. In some examples, the amount of the revenue is independent of the feedback.

U.S. Pat. No. 7,870,024 entitled “Systems and methods for electronic marketing” discloses an exemplary system which includes a publisher subsystem configured to communicate with an access device and an advertiser device over a data communication network. The publisher subsystem includes a publish module, a session module, and an allocation module. The publish module is configured to publish content over the data communication network, the content including an advertisement. The session module is configured to detect a selection of the advertisement, initiate a session between the access device and the advertiser device in response to the selection, the advertiser device being associated with the advertisement, and receive feedback from the advertiser device. The allocation module is configured to allocate revenue based on the feedback. In some examples, the amount of the revenue is independent of the feedback.

U.S. Pat. No. 7,827,128 entitled “System identification, estimation, and prediction of advertising-related data” discloses a system, method, and apparatus for analyzing advertisement-related data, which may include receiving data related to an aspect of an advertisement and modeling the aspect of the advertisement with a mathematical model. The mathematical model may include a control-signal-related component, a control-signal-independent component, and an error component. Each component may be updated based on at least one of a control signal, the received data, and a previous state of at least one of the components. An updated model may be created based on the updated components. The system, method, and apparatus may also include predicting the aspect of the advertisement using the updated model. Exemplary aspects of and data related to the advertisement may include one or more of the following: a number of impressions, “clicks,” or “conversions” and/or the impression-to-conversion, impression-to-click, or click-to-conversion ratios.

U.S. Pat. No. 7,653,748 entitled “Systems, methods and computer program products for integrating advertising within web content Systems”, discloses methods, and computer program products that facilitate the integration and accounting of advertising within audio Web content requested by users via telephone devices. Upon receiving a request from a user for Web content via a telephone device, a Web server retrieves an advertisement from an advertisement server, inserts the retrieved advertisement within the user requested Web content, and forwards the user requested Web content and advertisement to a text-to-speech transcoder for conversion to an audio format. The text-to-speech transcoder converts the Web content and advertisement from a text-based format to an audio format and serves the Web content and advertisement in the audio format to the user client device via a telephone link established with the user client device. If an advertisement is interactive, a text-to-speech transcoder may be configured to notify an advertisement server of user interaction with the advertisement. Information such as an identification of a requesting client device, user, as well as time and date information, may be recorded by an advertisement server for use in measuring effectiveness of a particular marketing and/or advertising campaign. Information associated with providing a user with additional information associated with an advertisement may also be stored.

U.S. Pat. No. 6,788,202 entitled “Customer conversion system” discloses a customer conversion system which connects existing, conventional sensors to a point of sale computer or other computer. Entries by people into a retail space so equipped are counted and recorded on a continuous or on a periodic interval basis.

U.S. patent application publication number US2011231239A discloses a method for identifying and crediting interactions leading to a conversion, comprising acts for each of at least one defined time interval, defining a recency factor used to scale a credit amount given to an influencing event occurring during the defined time interval; identifying at least one influencing event that influenced a conversion event; for each of the at least one influencing events, identifying a defined time interval in which the influencing event occurred and accessing the recency factor for that defined time interval; and apportioning the credit amount given to the conversion event among the at least one influencing event according to the recency factor for each influencing event.

United States Patent Application no. 20110213669 entitled “Allocation of Resources” discloses allocation of resources, and is described for example, where the resources are computers, communications network resources or advertisement slots. In an example a weighted proportional resource allocation mechanism is described in which a resource provider seeks to maximize revenue whilst users seek to maximize their satisfaction in terms of the utility of any resource allocation they receive minus any payment they make for the resource allocation. In an example, the provider determines discrimination weights (using information about resource constraints and other factors). For example, the discrimination weights are published to the users; the users submit bids for the resources in the knowledge of the discrimination weights and the provider allocates the resources according to the bids and the discrimination weights. In an example keyword auctions for sponsored search are considered where the resources are advertisement slots and where the constraints include the relative positions of the advertisements.

United States Patent Application no. 20100318432 entitled “Allocation of Internet Advertising Inventory” discloses a method for allocating inventory in a networked environment, and includes receiving a request to purchase a number of display impressions, the request including targeting parameters and a frequency constraint corresponding to a maximum number of times the advertisement can be displayed to a user. The method also includes allocating the requested number of display impressions across a set of user samples, where the number of impressions allocated to any one user sample in the set of user samples is constrained by the frequency constraint. Allocation information that defines how the impressions are allocated among the user samples is stored to a user sample database.

United States Patent Application no. 20100318413 entitled “Allocation of Internet Advertising Inventory” discloses a method for determining a price of a contract for booking advertising space in a networked environment which includes receiving, via a web server, a request to book a number of impressions from available impression inventory, where each impression corresponds to the delivery of an advertisement to a browser. The method also includes assembling user samples that represent a total amount of impression inventory, where each user sample represents a number of Internet users, calculating a value associated with each piece of remaining impression inventory of the total impression inventory, and evaluating the value of all remaining impression inventory before and after allocation to a contract by maximizing and equation subject to a set of constraints. The base price for the contract corresponds to the difference between the value of the inventory before and after allocation.

United States Patent Application no. 20100121679 entitled “Allocation and Pricing of Impression Segments of Online Advertisement Impressions for Advertising Campaigns” discloses an improved system and method for representative allocation and pricing of impression segments of online advertisement impressions for advertising campaigns. An inventory of online advertisement impressions may be grouped in impression segments according to attributes of the advertisement impressions and advertising campaigns for impressions targeting specific attributes may be received. A representative number of advertisement impressions from the impression segments may be determined for allocation to the advertising campaigns by maximizing the prices of the impression segments for each of the values of the advertising campaigns. The representative number of advertisement impressions from the impression segments may be allocated for the advertising campaigns, and the price of each of the advertising campaigns may be output for the allocated advertisement impressions.

United States Patent Application no. 20100114689 entitled “System for display advertising optimization using click or conversion performance” discloses an advertisement impression distribution system, and includes a data processing system operable to generate an allocation plan for serving advertisement impressions. The allocation plan allocates a first portion of advertisement impressions to satisfy guaranteed demand and a second portion of advertisement impressions to satisfy non-guaranteed demand. The data processing system includes an optimizer, the optimizer to establish a relationship between the first portion of advertisement impressions and the second portion of advertisement impressions. The relationship defines a range of possible proportions of allocation of the first portion of advertisement impressions and the second portion of advertisement impressions. The optimizer generates a solution in accordance with maximizing guaranteed demand fairness, non-guaranteed demand revenue and click or conversion value, where the solution identifies a determined proportion of the first portion of advertisement impressions to serve and a determined proportion of the second portion of advertisement impressions to serve. The data processing system outputs the allocation plan including the solution to control serving of the advertisement impressions in the determined proportions.

United States Patent Application no. 20100100414 entitled “Demand Forecasting System and Method for Online Advertisements” discloses a computer implemented system, and includes a computer readable storage medium which includes historical demand data for a plurality of advertising inventories, and a processor connected to the computer readable storage medium. The processor is configured for generating a first demand forecast for a first predetermined period of time and a second demand forecast for a second predetermined period of time. The processor is configured for adjusting the first demand forecast by removing an existing demand for each of the plurality of advertising inventories, and for generating a net forecasting demand for each of the plurality of inventories for a third predetermined period of time by combining the second demand forecast and an adjusted first demand forecast. The third predetermined period of time is based on the first and second predetermined periods.

United States Patent Application no. 20100088221 entitled “Systems and Methods for the Automatic Allocation of Business Among Multiple Entities” discloses systems and methods for allocating business among a plurality of entities. In some embodiments, information about the business may be communicated from a client terminal. If the business is capable of being automatically allocated, at least one relevant parameter may be processed to identify a provider with which to allocate the business. In some embodiments, motor vehicle dealership financing application allocation techniques are used to determine financing sources, financing eligibility, financing terms, or any combination thereof in connection with the sale or leasing of motor vehicles.

United States Patent Application no. 20090234722 entitled “System and Method for Computerized Sales Optimization” discloses a method for increasing the conversion rate, or the ratio of the number of actual buyers to the number of site visitors, of a computer-implemented system such as an Internet e-commerce website. Shopping cart abandonment may be reduced though the disclosed method wherein filler items are suggested to the consumer in order to qualify the consumer for a promotional bonus, such as free shipping. By simplifying the consumer's task of selecting filler items, the consumer may be more likely to consummate the sale instead of abandoning the shopping cart to find a better deal elsewhere. In the event no suitable filler items can be identified, alternative promotions may be presented to the consumer, for example, reduced rate shipping.

United States Patent Application no. 20090106100 entitled “Method of digital good placement in a dynamic, real time environment” discloses a method and system for advertising selection, placement management, payment and delivery in a dynamic, real-time environment wherein the production, listing, procurement, payment, real time management, re-allocation and financial settlement of all types of digital advertising mediums, with optional automated delivery for advertisement and messaging for such ads is performed. The planning, purchasing, delivery and payment for on-line and traditional media advertising is automated, standardized and tracked across multiple mediums, such as TV, Internet, satellite, radio, wireless telephone, outdoor screens, and other digital mediums that display dynamic content. As a result, transparency and discovery of price, performance and availability segmented by specific markets and customer profiles for specific products is achieved. A buyer/seller real time feedback is provided to allow both buyers and sellers to dynamically change existing ads, ad space, prices, etc, in a real time environment based on real time sale/conversion feedback.

United States Patent Application no. 20080228893 entitled “Advertising management system and method with dynamic pricing” discloses a method and system for enabling advertisers to deliver advertisements to consumers in which a plurality of tiers of available advertisements, each tier containing a number of advertisements, a price for allocation of an advertisement in each tier is set wherein a lowest tier has the lowest price and the price increases to a maximum at a highest tier, and advertisements are allocated to advertisers based on availability starting from a lowest tier with unallocated advertisements and progressing to higher tiers.

United States Patent Application no. 20080228583 entitled “Advertising management system and method with dynamic pricing” discloses a method and system for enabling advertisers to deliver advertisements to consumers in which a plurality of tiers of available advertisements are defined, each tier containing a number of advertisements, a price for allocation of an advertisement in each tier is set wherein a lowest tier has the lowest price and the price increases to a maximum at a highest tier, and advertisements are allocated to advertisers based on availability starting from a lowest tier with unallocated advertisements and progressing to higher tiers.

United States Patent Application no. 20070143186 entitled “Systems, apparatuses, methods, and computer program products for optimizing allocation of an advertising budget that maximizes sales and/or profits and enabling advertisers to buy media online” discloses a system, apparatus, methods, and computer program products enabling an advertiser to increase or maximize sales and/or profits of a company, brand, and/or product by determining the optimum size of an advertising budget and/or optimizing the allocation of an advertising budget to those media channels, operators within any given media channel, program/page provided by any given operator, and/or space within any given program/page, which generates the highest ratio of sales on invested capital, maximum sales, and/or maximum profits. A system and method of enabling an advertiser to input online the parameters of an advertising campaign, include, but are not limited to: the product category, the budget, the characteristics of the target customer, and the desired timing; generating an optimum allocation of said budget which generates the highest ratio of sales on invested capital, maximum sales, and/or maximum profits; enabling operators to offer online the availability of advertisement inventory on their programs/pages and/or spaces; automating the process of determining the optimum size of an advertising budget and/or optimizing the allocation of an advertising budget; integrating advertising planning and purchasing into an advertiser's enterprise resource planning system; enabling an advertiser to bid online to advertise on said programs/pages and/or spaces; and matching advertisers and operators to execute the purchase of said advertisement inventory.

United States Patent Application no. 20070033096 entitled “Method and System for Allocating Advertising Budget to Media in Online Advertising” discloses a method and system for allocating advertising budget to media in online advertising. The method provides an optimal media mix through selection and combination of media in order of high media reach estimates for respective budget allocation units based on the number of media for which budget will be executed. With the method, the media mix to optimize media effects of advertisement campaign can be simply deduced, thereby maximizing a return on investment (ROI) of a client.

U.S. patent application Ser. No. 13/598,925 entitled “System, Method and Computer Program Product for Attributing a Value”, assigned to the assignee of the present application, discloses a system operable to attribute a value associated with a series of user interactions to individual interactions in the series, the system including: (a) an interface, configured to obtain information of interactions which are included in the series of interactions; and (b) a processor on which an attribution module is implemented, the attribution module is configured to attribute an apportionment of the value to each out of a plurality of interactions of the series, based on a calibrated attribution scheme and on properties relating to at least one interaction out of the series of interactions, thereby enabling efficient utilization of communication resources.

### General Description

In accordance with an aspect of the presently disclosed subject matter, there is provided a first computerized predictive method, the method including executing by a processor: (a) obtaining information pertaining to interactions which are included in a series of user interactions, wherein at least one of the interactions of the series includes communication of digital media over a network connection; and (b) computing a performance assessment for the series of interactions, based on the obtained information and on an assessment scheme which is based on a statistical analysis of historical data of a plurality of series of interactions.

In accordance with an embodiment of the presently disclosed subject matter, there is further provided a computerized prediction method for individual users based on user interactions history, the method including executing the first computerized predictive method; wherein the series of user interactions is associated with a selected user, wherein at least one of the interactions of the series includes communication of digital media over a network connection to the selected user; wherein the computing includes: based on the obtained information with respect to the specific user and on the assessment scheme, computing the performance assessment for the series of interactions associated with the selected user; wherein the computing is based on properties relating to at least one interaction out of the series of interactions, wherein the properties include properties of at least one subset of interactions of the series, wherein the subset includes multiple interactions and at least one property out of the following types: (a) properties quantifying relative quality of the interactions, (b) types of communication channels used by the respective interactions.

Reverting to the first computerized predictive method, the first computerized predictive method may further include assigning a value to the series based on the performance assessment.

In accordance with an embodiment of the presently disclosed subject matter, there is further provided a method for lead generation, the method including: (a) for each out of multiple series of interactions, each of the series being associated with a different user: assigning a value to the series according to the first computerized predictive method, thereby assigning different values to the different users associated with the respective series; (b) exchanging contact details of the different users with a third party in return for transactions by the third party whose content is determined in response to the values assigned to the different users.

In accordance with an embodiment of the presently disclosed subject matter, there is further provided a computerized method for communication with real time bidding servers, the method including: (a) according to the first computerized predictive method, computing for each out of multiple series of interactions a performance assessment which is an assessment of an optional future conversion to which that series of interactions may lead; wherein each out of the multiple series includes at least one interaction which complies with a predefined criterion; (b) based on the computed performance assessments, updating a value assignment parameter; and (c) selectively initiating a communication of digital media which complies with the predefined criterion, wherein the selective initiation of the communication includes bidding on an advertisement, wherein a magnitude of the bidding is based on the value assignment parameter.

In accordance with an embodiment of the presently disclosed subject matter, there is further provided a computerized method for inventory management, the method including: (a) according to the first computerized predictive method, computing for each out of multiple series of interactions a performance assessment which is an expected magnitude of an optional future transaction to which that series of interactions may lead; wherein each out of the multiple series includes at least one interaction which complies with a predefined criterion; (b) based on the computed performance assessments, determining an expected inventory of at least one item to be transacted in the optional future transactions; and (c) selectively initiating a communication of digital media which complies with the predefined criterion, based on the expected inventory.

In accordance with an embodiment of the presently disclosed subject matter, the first computerized predictive method may further include statistically analyzing the historical data of the plurality of series of interactions, and determining the assessment scheme based on a result of the analyzing.

In accordance with an embodiment of the presently disclosed subject matter, the computing of the first computerized predicative method may be based on properties relating to at least one interaction out of the series of interactions, wherein the statistical analysis is based on frequencies of patterns of interactions having the properties.

In accordance with an embodiment of the presently disclosed subject matter, there is further provided a computerized method for communication, the method including: (a) obtaining information pertaining to interactions which are included in an original series of user interactions, wherein at least one of the interactions of the original series includes communication of digital media over a network connection; (b) based on the obtained information, defining multiple possible future interactions which may occur after the original series of interactions; (c) for each out of multiple hypothetical series of interactions, each of the multiple hypothetical series of interactions includes the original series and at least one of the multiple possible future interactions, computing a performance assessment according to the first computerized predicative method; (c) selecting one or more out of the possible future interactions based on the performance assessment computed for different hypothetical series; and (d) executing the selected possible future interactions.

In accordance with an embodiment of the presently disclosed subject matter, the first computerized predicative method may be used for retargeting a selected user with an advertisement which is selected based on previous Internet interactions with the selected user, wherein the selecting includes selecting an advertisement out of multiple possible advertisements, and wherein the executing includes presenting the selected advertisement to the selected user.

In accordance with an embodiment of the presently disclosed subject matter, the computing of the first computerized predicative method may be based on properties relating to at least one interaction out of the series of interactions, wherein the properties include at least one property which is unrelated to a time in which any of the interactions occurred.

In accordance with an embodiment of the presently disclosed subject matter, the properties may include properties quantifying relative quality of the interactions.

In accordance with an embodiment of the presently disclosed subject matter, the properties may include types of communication channels used by the respective interactions.

In accordance with an embodiment of the presently disclosed subject matter, the properties may include properties of at least one subset of interactions of the series, wherein the subset includes multiple interactions.

In accordance with an embodiment of the presently disclosed subject matter, the properties may include properties which pertain to the creative media used in an advertisement involved in at least one of the respective interactions.

In accordance with an embodiment of the presently disclosed subject matter, the computing of the first computerized predicative method may be based on a pattern occurring in at least one property of the interactions across the series of interactions.

In accordance with an aspect of the presently disclosed subject matter, there is further provided a second computerized prediction method for assessing an optional future conversion of a selected user based on a history of interactions with the selected user, the method including executing by a processor: (a) obtaining information pertaining to interactions with the selected user which are included in a series of user interactions associated with the selected user, wherein at least one of the interactions of the series includes communication of digital media over a network connection; and (b) computing a conversion assessment for the series of interactions, based on the obtained information and on an assessment scheme which is based on a statistical analysis of historical data of a plurality of series of interactions; wherein the conversion assessment pertains to the optional future conversion of the selected user which is valuable to an advertiser whose digital media was communicated to the selected user in at least one interaction of the series.

In accordance with an aspect of the presently disclosed subject matter, the first and/or the second computerized predictive methods may further include selectively applying at least one industrial process in response to the performance assessment. Such applying of an industrial process may be used, for example, for enabling efficient utilization of communication resources.

In accordance with an aspect of the presently disclosed subject matter, the first and/or the second computerized predictive methods may further include statistically analysis executed for detecting synergy between different types of interactions, wherein the computing of the performance assessment is based on the detected synergy.

In accordance with an aspect of the presently disclosed subject matter, the first and/or the second computerized predictive methods may further include repeatedly updating the assessment scheme, wherein each updating is based on historical data which is more recent than any of the previous instances of updating.

In accordance with an aspect of the presently disclosed subject matter, the computing of the first and/or the second computerized predictive methods may include computing the performance assessment based on properties of elements that triggered interactions of the series.

In accordance with an aspect of the presently disclosed subject matter, the computing of the first and/or the second computerized predictive methods may include computing the performance assessment based on properties which pertain to an advertised entity associated with at least one interaction of the series of interactions.

In accordance with an aspect of the presently disclosed subject matter, the computing of the first and/or the second computerized predictive methods may include computing the performance assessment based on properties of at least one keyword entered by a user which triggered at least one interaction of the series.

In accordance with an aspect of the presently disclosed subject matter, the computing of the first and/or the second computerized predictive methods may include computing the performance assessment based on properties which pertain to an advertisement provided to a user in at least one of the interactions of the series.

In accordance with an aspect of the presently disclosed subject matter, the computing of the first and/or the second computerized predictive methods may enable reducing an amount of data communicated to the at least one user, thereby reducing an amount of communication resources.

In accordance with an aspect of the presently disclosed subject matter, the computing of the first and/or the second computerized predictive methods may be based on information pertaining to interactions which are included in multiple interconnected series of interactions which are associated with multiple users, the multiple interconnected series of interactions includes the aforementioned series of interactions.

In accordance with an aspect of the presently disclosed subject matter, at least one out of the series of interactions is a conversion.

In accordance with an aspect of the presently disclosed subject matter, there is further provided a system operable to computing a performance assessment, the system including: (a) an interface, configured to obtain information of interactions which are included in a series of interactions, wherein at least one of the interactions of the series includes communication of digital media over a network connection; and (b) a processor on which a performance assessment module is implemented, the performance assessment module is configured to compute a performance assessment for the series of interactions, based on the obtained information and on an assessment scheme which is based on a statistical analysis of historical data of a plurality of series of interactions.

In accordance with an embodiment of the presently disclosed subject matter, the system may further include an assessment scheme processing module which is configured to statistically analyze the historical data of the plurality of series of interactions, and to determine the assessment scheme based on a result of the analyzing.

In accordance with an embodiment of the presently disclosed subject matter, the performance assessment module may be configured to compute the performance analysis based on properties relating to at least one interaction out of the series of interactions, wherein the statistical analysis of the assessment scheme processing module is based on frequencies of patterns of interactions having the properties.

In accordance with an embodiment of the presently disclosed subject matter, the statistical analysis of the assessment scheme processing module may be based on relative success of sets of interactions having certain patterns of interactions with respect to success of other sets of interactions having other patterns of interactions.

In accordance with an embodiment of the presently disclosed subject matter, the performance assessment module may be configured to compute the performance assessment based on properties relating to at least one interaction out of the series of interactions, wherein the properties include at least one property which is unrelated to a time in which any of the interactions occurred.

In accordance with an embodiment of the presently disclosed subject matter, the properties may include properties quantifying relative quality of the interactions.

In accordance with an embodiment of the presently disclosed subject matter, the properties may include types of communication channels used by the respective interactions.

In accordance with an embodiment of the presently disclosed subject matter, the properties may include properties of at least one subset of interactions of the series, wherein the subset includes multiple interactions.

In accordance with an aspect of the presently disclosed subject matter, the properties may include properties which pertain to the creative media used in an advertisement involved in at least one of the respective interactions.

In accordance with an embodiment of the presently disclosed subject matter, the performance assessment module may be configured to compute the performance assessment based on a pattern occurring in at least one property of the interactions across the series of interactions.

In accordance with an embodiment of the presently disclosed subject matter, there is further provided a system, wherein at least one out of the series of interactions is a conversion.

In accordance with an aspect of the presently disclosed subject matter, the system may be configured selectively applying at least one industrial process in response to the performance assessment.

In accordance with an aspect of the presently disclosed subject matter, the system may be configured to execute statistic analyzing for detecting synergy between different types of interactions, wherein the computing of the performance assessment is based on the detected synergy.

In accordance with an aspect of the presently disclosed subject matter, the system may be further configured to repeatedly update the assessment scheme, wherein each updating is based on historical data which is more recent than any of the previous instances of updating.

In accordance with an aspect of the presently disclosed subject matter, the processor may be configured to compute the performance assessment based on properties of elements that triggered interactions of the series.

In accordance with an aspect of the presently disclosed subject matter, the processor may be configured to compute the performance assessment based on properties which pertain to an advertised entity associated with at least one interaction of the series of interactions.

In accordance with an aspect of the presently disclosed subject matter, the processor may be configured to compute computing the performance assessment based on properties of at least one keyword entered by a user which triggered at least one interaction of the series.

In accordance with an aspect of the presently disclosed subject matter, the processor may be configured to compute computing the performance assessment based on properties which pertain to an advertisement provided to a user in at least one of the interactions of the series.

In accordance with an aspect of the presently disclosed subject matter, the computing of the performance assessment by the processor enables reducing an amount of data communicated to the at least one user, thereby reducing an amount of communication resources.

In accordance with an aspect of the presently disclosed subject matter, the processor may be configured to compute the performance assessment based on information pertaining to interactions which are included in multiple interconnected series of interactions which are associated with multiple users, the multiple interconnected series of interactions includes the aforementioned series of interactions.

In accordance with an aspect of the presently disclosed subject matter, there is further provided a system wherein at least one out of the series of interactions is a conversion.

In accordance with an aspect of the presently disclosed subject matter, there is further provided a program storage device readable by machine, tangibly embodying a first program of instructions executable by the machine to perform a method which includes the steps of: (a) obtaining information pertaining to interactions which are included in a series of user interactions, wherein at least one of the interactions of the series includes communication of digital media over a network connection; and (b) computing a performance assessment for the series of interactions, based on the obtained information and on an assessment scheme which is based on a statistical analysis of historical data of a plurality of series of interactions.

In accordance with an embodiment of the presently disclosed subject matter, there is further provided a program storage device readable by machine, tangibly embodying a program of instructions executable by the machine to perform a prediction method for individual users based on user interactions history, the program of instructions including the instructions of the first program of instructions, wherein the series of user interactions is associated with a selected user, wherein at least one of the interactions of the series includes communication of digital media over a network connection to the selected user; wherein the computing includes: based on the obtained information with respect to the specific user and on the assessment scheme, computing the performance assessment for the series of interactions associated with the selected user; wherein the computing is based on properties relating to at least one interaction out of the series of interactions, wherein the properties include properties of at least one subset of interactions of the series, wherein the subset includes multiple interactions and at least one property out of the following types: (a) properties quantifying relative quality of the interactions, (b) types of communication channels used by the respective interactions.

In accordance with an embodiment of the presently disclosed subject matter, there is further provided a program storage device, further including assigning a value to the series based on the performance assessment.

In accordance with an embodiment of the presently disclosed subject matter, there is further provided a program storage device readable by machine, tangibly embodying a program of instructions executable by the machine to perform a method for communication with real time bidding servers, the program of instructions including instructions for: (a) according to the instructions of the first program of instructions, computing for each out of multiple series of interactions a performance assessment which is an assessment of an optional future conversion to which that series of interaction may lead; wherein each out of the multiple series includes at least one interaction which complies with a predefined criterion; (b) based on the computed performance assessments, updating a value assignment parameter; and (c) selectively initiating a communication of digital media which complies with the predefined criterion, wherein the selective initiation of the communication includes bidding on an advertisement, wherein a magnitude of the bidding is based on the value assignment parameter.

In accordance with an embodiment of the presently disclosed subject matter, there is further provided a program storage device readable by machine, tangibly embodying a program of instructions executable by the machine to perform a method for inventory management, the program of instructions including instructions for: (a) according to the instructions of the first program of instructions, computing for each out of multiple series of interactions a performance assessment which is an expected magnitude of an optional future transaction to which that series of interaction may lead; wherein each out of the multiple series includes at least one interaction which complies with a predefined criterion; (b) based on the computed performance assessments, determining an expected inventory of at least one item to be transacted in the optional future transactions; and (c) selectively initiating a communication of digital media which complies with the predefined criterion, based on the expected inventory.

In accordance with an embodiment of the presently disclosed subject matter, there is further provided a program storage device, further including statistically analyzing the historical data of the plurality of series of interactions, and determining the assessment scheme based on a result of the analyzing.

In accordance with an embodiment of the presently disclosed subject matter, there is further provided a program storage device, wherein the computing is based on properties relating to at least one interaction out of the series of interactions, wherein the statistical analysis is based on frequencies of patterns of interactions having said properties.

In accordance with an embodiment of the presently disclosed subject matter, there is further provided a program storage device, wherein the statistical analysis is based on relative success of sets of interactions having certain patterns of interactions with respect to success of other sets of interactions having other patterns of interactions.

In accordance with an embodiment of the presently disclosed subject matter, there is further provided a program storage device readable by machine, tangibly embodying a program of instructions executable by the machine to perform a method for communication, the program of instructions including instructions for: (a) obtaining information pertaining to interactions which are included in an original series of user interactions, wherein at least one of the interactions of the original series includes communication of digital media over a network connection; (b) based on the obtained information, defining multiple possible future interactions which may occur after the original series of interactions; (c) for each out of multiple hypothetical series of interactions, each of the multiple hypothetical series of interactions includes the original series and at least one of the multiple possible future interactions, computing a performance assessment according to the instructions of the first program of instructions; and (d) selecting one or more out of the possible future interactions based on the performance assessment computed for different hypothetical series; and executing the selected possible future interactions.

In accordance with an embodiment of the presently disclosed subject matter, there is further provided a program storage device, wherein the computing is based on properties relating to at least one interaction out of the series of interactions, wherein the properties include at least one property which is unrelated to a time in which any of the interactions occurred.

In accordance with an embodiment of the presently disclosed subject matter, there is further provided a program storage device, wherein the properties include properties quantifying relative quality of the interactions.

In accordance with an embodiment of the presently disclosed subject matter, there is further provided a program storage device, wherein the properties include types of communication channels used by the respective interactions.

In accordance with an embodiment of the presently disclosed subject matter, there is further provided a program storage device, wherein the properties include properties of at least one subset of interactions of the series, wherein the subset includes multiple interactions.

In accordance with an aspect of the presently disclosed subject matter, there is further provided a program storage device wherein the properties include properties which pertain to the creative media used in an advertisement involved in at least one of the respective interactions.

In accordance with an embodiment of the presently disclosed subject matter, there is further provided a program storage device, wherein the computing is based on a pattern occurring in at least one property of the interactions across the series of interactions.

In accordance with an embodiment of the presently disclosed subject matter, there is further provided a program storage device selectively applying at least one industrial process in response to the performance assessment (e.g. thereby enabling efficient utilization of communication resources.)

In accordance with an embodiment of the presently disclosed subject matter, there is further provided a program storage device, wherein statistically analyzing is executed for detecting synergy between different types of interactions, wherein the computing of the performance assessment is based on the detected synergy.

In accordance with an embodiment of the presently disclosed subject matter, there is further provided a program storage device, wherein further including repeatedly updating the assessment scheme, wherein each updating is based on historical data which is more recent than any of the previous instances of updating.

In accordance with an embodiment of the presently disclosed subject matter, there is further provided a program storage device, wherein the computing includes computing the performance assessment based on properties of elements that triggered interactions of the series.

In accordance with an embodiment of the presently disclosed subject matter, there is further provided a program storage device, wherein the computing includes computing the performance assessment based on properties which pertain to an advertised entity associated with at least one interaction of the series of interactions.

In accordance with an embodiment of the presently disclosed subject matter, there is further provided a program storage device, wherein the computing includes computing the performance assessment based on properties of at least one keyword entered by a user which triggered at least one interaction of the series.

In accordance with an embodiment of the presently disclosed subject matter, there is further provided a program storage device, wherein the computing includes computing the performance assessment based on properties which pertain to an advertisement provided to a user in at least one of the interactions of the series.

In accordance with an embodiment of the presently disclosed subject matter, there is further provided a program storage device, wherein the computing is enables reducing an amount of data communicated to the at least one user, thereby reducing an amount of communication resources.

In accordance with an embodiment of the presently disclosed subject matter, there is further provided a program storage device, wherein the computing is based on information pertaining to interactions which are included in multiple interconnected series of interactions which are associated with multiple users, the multiple interconnected series of interactions includes the aforementioned series of interactions.

In accordance with an embodiment of the presently disclosed subject matter, there is further provided a program storage device, wherein at least one out of the series of interactions is a conversion.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 illustrates a system which is operable to compute a performance assessment for a series of interactions, according to an embodiment of the invention;

Each of FIGS. 2A through 2E illustrates a series of interactions on which various aspects of the invention may be exemplified;

FIGS. 3A, 3B, 4 and 5 illustrate computerized methods, according to embodiments of the invention;

FIG. 6 illustrates two series of interactions as well as two patterns, according to an embodiment of the invention; and

FIG. 7 illustrates an original series and two hypothetical series derived therefrom, according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “processing”, “calculating”, “determining”, “generating”, “setting”, “configuring”, “selecting”, “assigning”, “attributing”, “computing”, or the like, include action and/or processes of a computer that manipulate and/or transform data into other data, said data represented as physical quantities, e.g., such as electronic quantities, and/or said data representing the physical objects. The terms “computer”, “processor”, “processing module” and like terms should be expansively construed to cover any kind of electronic device with data processing capabilities, including, by way of non-limiting example, a personal computer, a server, a computing system, a communication device, a processor (e.g., digital signal processor (DSP), a microcontroller, a field programmable gate array (FPGA), an application specific integrated circuit (ASIC), etc.), any other electronic computing device, and or any combination thereof.

The operations in accordance with the teachings herein may be performed by a computer specially constructed for the desired purposes or by a general purpose computer specially configured for the desired purpose by a computer program stored in a computer readable storage medium.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

In embodiments of the presently disclosed subject matter one or more stages illustrated in the figures may be executed in a different order and/or one or more groups of stages may be executed simultaneously and vice versa. The figures illustrate a general schematic of the system architecture in accordance with an embodiment of the presently disclosed subject matter. Each module in the figures can be made up of any combination of software, hardware and/or firmware that performs the functions as defined and explained herein. The modules in the figures may be centralized in one location or dispersed over more than one location.

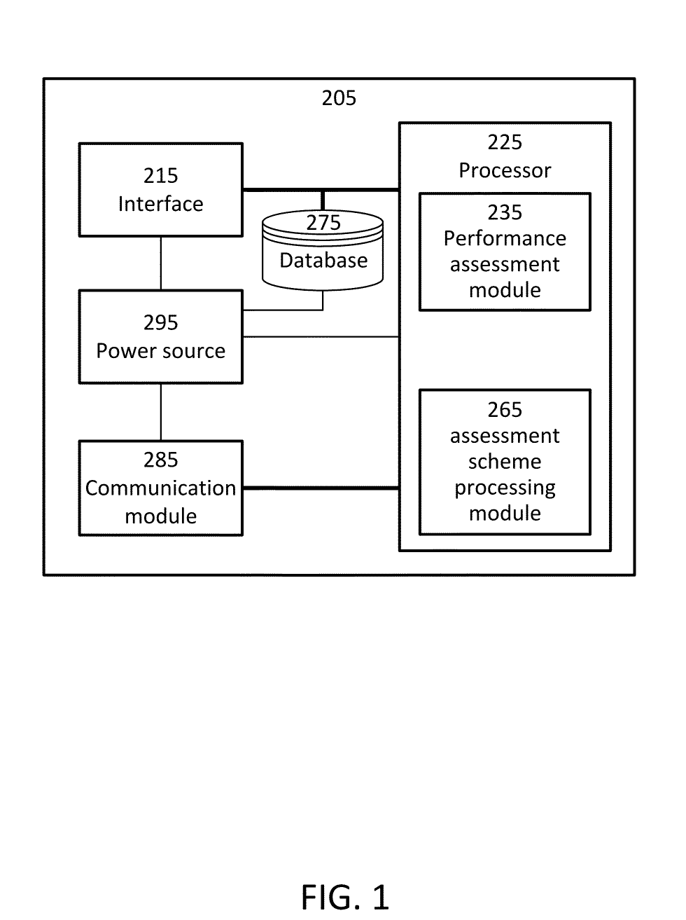

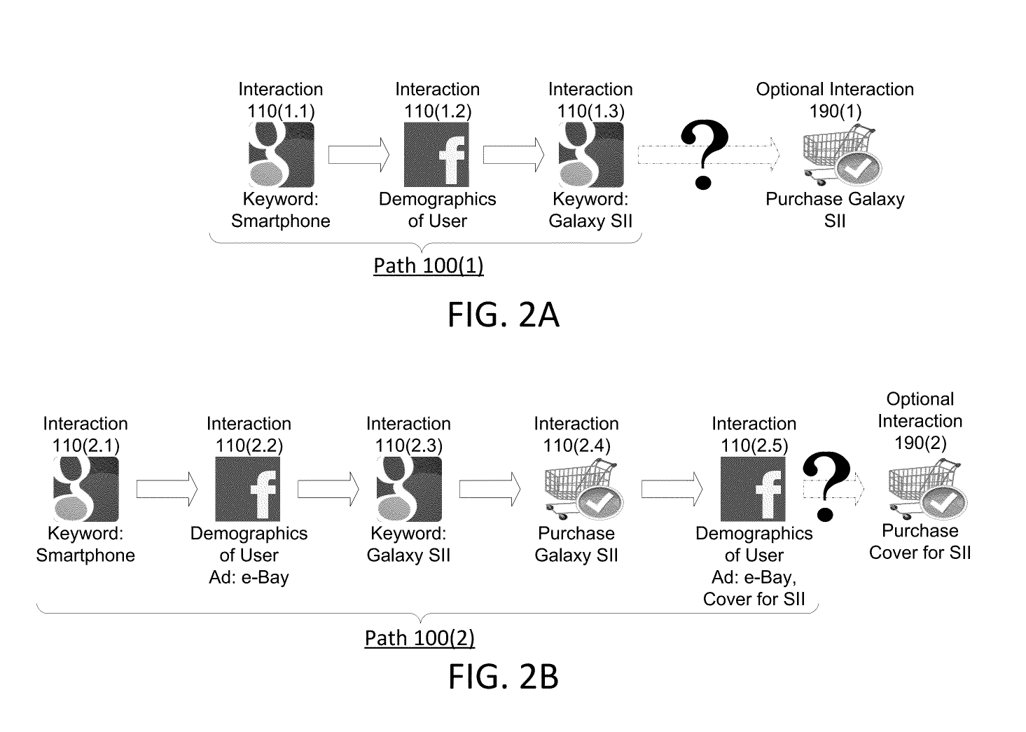

FIG. 1 illustrates system 205 which is operable to compute a performance assessment for a series of interactions, according to an embodiment of the invention. System 205 includes interface 215 which is configured to obtain information of interactions which are included in the series of interactions and processor 225, on which various processing modules may be implemented. At least one of the interactions of the series includes communication of digital media over a network connection. As will be clear to a person who is of skill in the art, system 205 may include various additional components (such as power source 295), which may be required or useful for effective operation of system 205. Since those components are not necessary for the understanding of the invention, they are not illustrated, thereby making the discussion clearer.

One of the modules implemented on the processor is a performance assessment module 235. Performance assessment module 235 is configured to compute a performance assessment for the series of interactions, based on the obtained information (i.e. the information obtained by interface 215 of interactions which are included in the series of interactions), and further based on an assessment scheme which is based on a statistical analysis of historical data of a plurality of series of interactions.

As discussed below in greater detail, the obtained information on which performance assessment module 235 bases its computing of the performance assessment may be based on properties of individual interactions of the series, or on properties of subgroups containing some or all of the interactions of the series (e.g. patterns, as discussed below). Optionally the group of properties on which the computing is based includes at least one property which is unrelated to a time in which any of the interactions occurred. Specifically, at least one of the properties is not related to any of the following:
a. a time in which any of the interactions occurred;
b. time passed between any two of more of the interactions of the series;
c. time passed between any of the interactions to another event or point in time;
d. relation of order between any two or more of the interactions of the series.

It is however noted that while not necessarily so, some of the properties of the interactions on which attribution is based may nevertheless be related to time (e.g., in addition to other properties such as the type of channel over which one or more of the interactions occurred).

The ways in which system 205 may operate according to various implementations of the invention would be clearer in view of the discussion of method 600, which may be executed by system 205. It is noted that the various implementations and variations of method 600 may be implemented by system 205 and its various components, even if not explicitly elaborated.

Optionally, the performance assessment module may be configured to compute the performance assessment based on the properties relating to the at least one interaction and further based on a calibrated attribution scheme.

Each of FIGS. 2A through 2E illustrates a series 100 of interactions 110 on which various aspects of the invention may be exemplified. Some such series of interactions are also occasionally referred to in the art (as well as in the present disclosure) as “paths” and may also be referred to as “path to conversion” (P2C), or as “conversion funnel”. It is however noted that, while not necessarily so, the performance assessment computed for the series 100 may be a likelihood that the series 100 would ultimately (or within a time span T) lead to a conversion, and therefore the series 100 may optionally not include any conversion. As will be discussed below, since a series 100 which includes a conversion (and even a series that ends with a conversion) may nevertheless ultimately lead to another conversion (e.g. purchase of another item), a likelihood that the series 100 would lead to a conversion may be computed for series which includes another conversion.

FIG. 2A illustrates series 100(1) of three interactions 110. An optional future interaction 190(1) is also illustrated in FIG. 2A, the likelihood of its occurring may be estimated when computing the performance assessment. In the illustrated example, optional future interaction 190(1) is a conversion. It should be noted that when computing the performance assessment, the optional interaction 190 has not yet occurred (and may never occur). FIG. 2B illustrates series 100(2) that includes a conversion in the middle of the series (conversion 110(2.4)).

FIG. 2C illustrates series 100(3) that includes two-users interactions (user A and user B), wherein in some of the interactions (e.g., interactions 110(3.1) and 110(3.6)) only one of the users is a party (the other party in those examples is the marketer), and in some of the interactions two users are party to the interaction (e.g., interactions 110(3.6), in which user A uses a website of the marketer to send an e-mail that includes advertising material to user B).

It is noted that while a single series of interactions may include interactions with more than one user (as in the example of FIG. 2C), and hence may be referred to as a social engagement graph, such a series may also be regarded as multiple interconnected series of interactions. Optionally, the computing of stage 640 may include computing at least one performance assessment based on interactions of multiple interconnected series of user interactions which are associated with multiple users (a performance assessment may be computed to any one or more of these interconnected series).

FIGS. 2D and 2E illustrate two series of interactions (110(4) and 110(5)) in which the optional interaction 190 whose likelihood of occurrence is computed is not a conversion but rather another type of an interaction. In the example of FIG. 2E, neither does the series 100(5) include any conversion nor is the optional interaction 190 a conversion.

While, as discussed below, different types of interactions may be included in different series of interactions, some or all of the interactions are interactions with one or more users. Such interactions are also referred to as “user interactions”. This refers to interactions of the series as well as to the optional interaction 190 where applicable.

Generally, among the types of user interactions which may be included in the series are any engagements of a user with any digitally represented media (e.g., software, application, digital display), which contains or associates (links) to an advertiser's brand, content and products.

For simplicity of explanation, only a few types of interactions with a user are illustrated in those figures, and therefore discussed in more detail in the examples. The illustrated interactions represent:
a. Clicking by the user on an advertisement presented to him after searching a search engine (represented by a Google™ logo), e.g., interaction 110(1.1);
b. Clicking by the user on an advertisement presented to him at a social network, e.g., based on demographics (and other characteristics) of the user (represented by a Facebook™ logo), e.g., interaction 110(1.2);
c. Conversions, e.g., purchase of a product by the user, signing-in to a website or a service, etc. (represented by a shopping-cart), e.g., optional interaction 190(1);
d. Social network interactions (e.g., “liking” or sharing by the user of an advertisement, a product, or a page of an marketer, also represented by the Facebook® logo or the Like® logo), e.g., interaction 110(3.5);
e. E-mail sent to the user (e.g., triggered by the marketer or by another user, represented by an envelope), e.g., interaction 110(3.6).

Many other types of interactions are known in the art, and information thereabout may be used in the proposed systems and methods. For example, such types of interactions include: exposure to an advertisement without clicking it (impressions) in social networks or elsewhere; clicking on a link to a web site that appears on another's user social network page (also known as ‘news feed’ or ‘wall’ (on Facebook®); checks-in a place (i.e., proved digital notification of his current location) using a location-based social networking website for mobile devices (e.g., Foursquare®); clicking on a display advertisement (e.g., a banner), viewing an advertisement, playing a promotional video, clicking a link on a website such as Youtube™, Fanning event, and more.

It should be noted that the arrows in FIGS. 2A through 2E do not necessarily indicate a causal relationship between the two interactions (even though such relationships may indeed occur). Such arrows represent an order of the interactions in the respective series.

The series of interactions (herein referred to as S) may be a totally ordered set of interactions (i.e., fulfilling the conditions of Reflexivity {a≦a for all interactions aεS}; Antisymmetry {a≦b and b≦a implies a=b}; Transitivity {a≦b and b≦c implies a≦c}; and Comparability {for any pair of interactions of the series a,bεS, either a≦b or b≦a}. The order may be a temporal order, but this is not necessarily so.

However, in other implementations, the series is not necessarily or totally an ordered set of interactions. For example, some implementations may require only a series which is a partially ordered set (in which only the conditions of Reflexivity, Antisymmetry, and Transitivity are required, but not the condition of Comparability). In yet additional implementations, the series is not even required to comply with all of the conditions for a partially ordered set.

Each of the interactions is associated with information regarding the interaction itself, and/or information pertaining to associated interactions, events, entities, and so on. Clearly, the information associated with each of the interactions may depend on the type of interactions.

Such information may pertain, for example, to any one or more of the following: type of the interaction, information transmitted during the interaction, length of the interaction, estimated value of the interaction, identity of one or more participants of the interaction, information regarding to more or more of the participants of the interaction, historic events which triggered the interaction, historic event which preceded the interaction, actions included in the interaction, and so on and so forth.

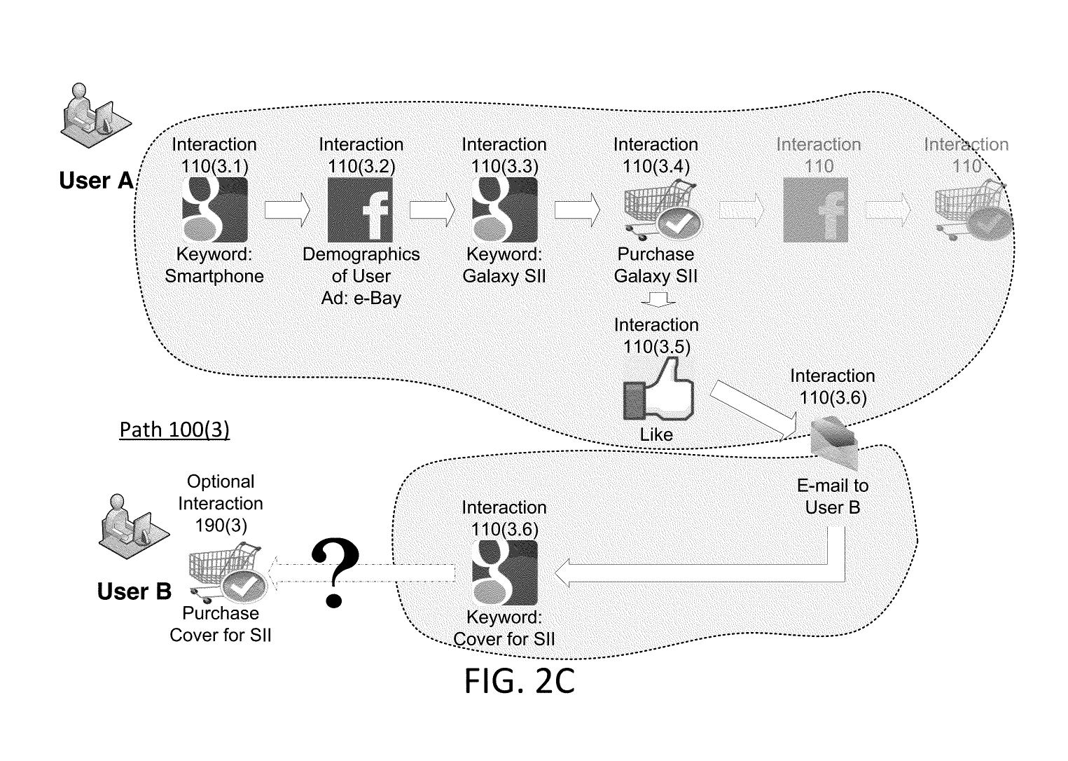

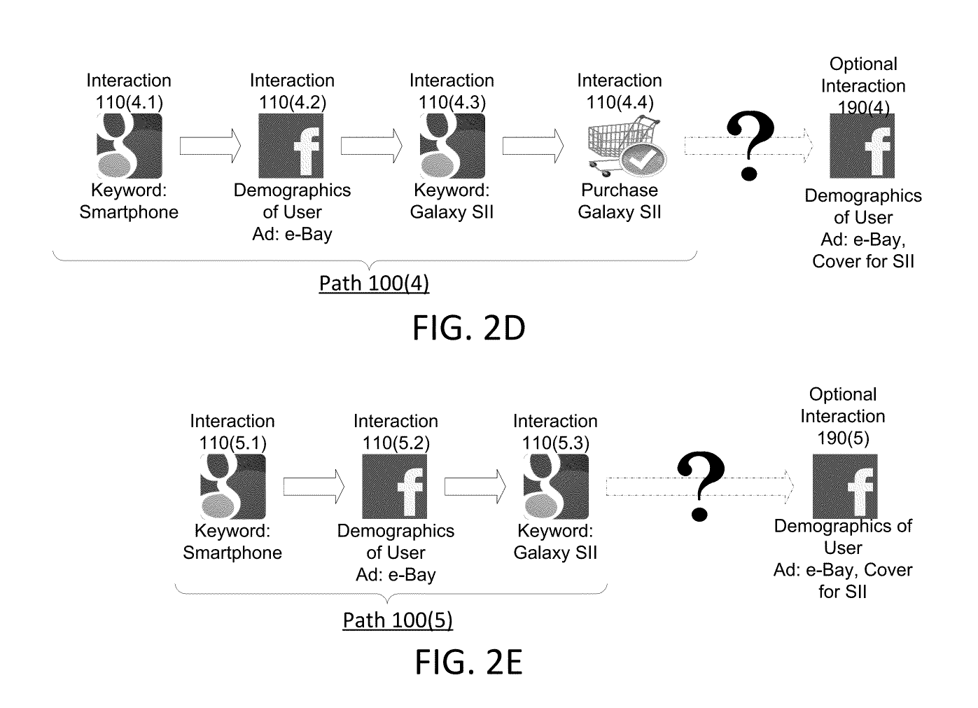

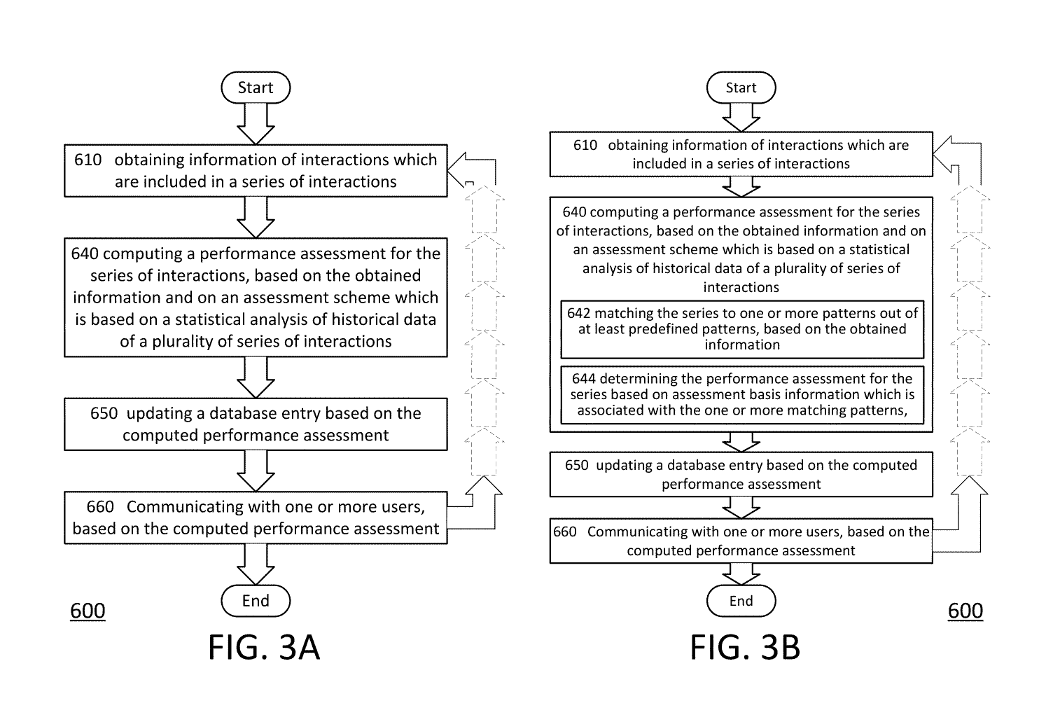

FIGS. 3A and 3B illustrate computerized method 600, according to an embodiment of the invention. Method 600 includes, among other stages, a stage of computing a performance assessment for a series of interactions. The computing of the performance assessment may be a target of method 600, or a step used as a basis for other actions, e.g. as discussed below. For example, such computing of performance assessment may enable efficient utilization of various communication resources (which may include advertising resources, communication hardware resources, communication channel resources, and so on).

Referring to the examples set forth with respect to the previous drawings, method 600 may be carried out by a system such as system 205, and especially by one or more processing modules thereof (each implemented by at least one tangible hardware processor).

The series of user interactions (a few examples of which are illustrated in FIGS. 2A through 2E) may include all of the interactions (of which data exists) with a single user (or with multiple users, especially of those which are related to each other, e.g., via one of the interactions), but other grouping conditions may also be applied. For example, the series may be limited only to interactions which occurred within a predefined time frame, only to interactions over preselected channels, only to interactions pertaining to a subgroup of advertised products but not to others, and so on.

One example of a series of interactions is a series of interactions which may optionally lead to a conversion (a path to conversion). For example, a conversion may be purchasing a product online, joining a mailing list, voting in a survey, “Like”-ing, “+1”-ing or “Tweet”-ing a page on a website, “Like”-ing a page on Facebook and so on. The series of interactions may not include all of the interactions of the marketer with the user. Some interactions may be irrelevant (e.g., the user may have searched for several unrelated products but only some of these interactions are relevant for an optional future purchase of a selected one of them), while some of the interactions may be unaccounted for (e.g., the user may have seen a billboard advertisement of the marketer, or have seen another person using the product).

It should be noted that while method 600 (and likewise system 205) are exemplified in many of the examples below with respect to Internet-based interactions and to advertising, they are not limited to such implementations.

Some examples of series of user interactions which include interactions with more than one user are: User A's ‘like’ can trigger an interaction for user B (thus two separate interactions); User B seeing that User A ‘liked’ a product or company on his Facebook® feed, and then clicking on the link; User B seeing an ad on Facebook® for a company or product and the ad informed him that his friend, User A ‘liked’ that company or product (this is also referred to as a social impression).

Other examples of cross-user interactions are possible, for example, social earned media—as user A fan event (e.g., ‘like’) may be displayed on his friend's (e.g., User B) social page feed (e.g., wall) causing user B to interact with the advertised content through an impression, and possible other, subsequent interactions.

Stage 610 of method 600 includes obtaining information of interactions which are included in the series of interactions. At least one of the interactions of the series includes communication of digital media over a network connection. Referring to the examples set forth with respect to the previous drawings, stage 610 may be carried out by an interface such as interface 215 (either by instructions from processor 225, or otherwise). The information obtained in stage 610 may pertain to all of the interactions of the series, or only to some of them. Hereinbelow it is assumed that the series only includes interactions for which information is obtained, and it is noted that an original series may be used to define a series that only includes interactions for which information is obtained.

As aforementioned, at least one of the interactions of the series includes communication of digital media over a network connection. Such interactions may include the previously offered examples or other types of interactions such as—clicking or viewing by the user of an digital media advertisement, digital purchase of a product, and possibly digital transaction (e.g. provisioning of a purchased mp3 file), signing-in to a website or a service, social media interactions, e-mails, television advertisements, smart TV advertisements, and so on. However, the series of interactions may also include other types of interactions of which information is available, such as—mailing a physical catalogue to the user, identifying the user in a physical location (e.g. by location-based social networking such as “Four Square™”), a sale-talk in a physical store, etc.

Stage 610 of obtaining information may include obtaining information pertaining to the individual interactions (e.g., information such as that exemplified above), and may also include obtaining information pertaining to groups of interactions (either the entire series or parts thereof). For example, information pertaining to groups of interactions may include statistics regarding the interactions (e.g., the amount of social media interactions, total time spent by the user in a website of the marketer in all of the interactions, average time between interactions, total number of interactions, time from first interaction to conversion etc.).

Stage 610 may include generating some or all of the information obtained, receiving some or all of the information obtained, and/or selecting some or all of the information obtained out of larger database.

It is noted that method 600 may also include (e.g., as part of stage 610) defining the series of interactions. For example, such a stage of defining may include selecting a group of interactions out of a larger database of interactions. Similar to the discussion above, the defining of the series may include selecting a group which includes all of the interactions that comply to one or more selection criteria: e.g., interactions with a group of one or more identified users, interactions occurring within a predefined time frame, interactions over a group of one or more preselected advertising channels, interactions pertaining to a subgroup of advertised products but not to others, and so on.

Method 600 continues with stage 640 of computing a performance assessment for the series of interactions, based on the obtained information and on an assessment scheme which is based on a statistical analysis of historical data of a plurality of series of interactions. As discussed below, the computing of the performance assessment may be based on properties of the individual interactions of the series and/or on properties pertaining to more than one interaction of the series. Optionally, stage 640 may include computing the performance assessment based on a calibrated assessment scheme and on the properties relating to the at least one interaction out of the series of interactions. The assessment scheme may be determined by a human expert but may also be determined by a computer processor (e.g., based on statistics of many series of interactions).

As discussed below in greater detail, optionally the group of properties on which the computing of stage 640 is based includes at least one property which is unrelated to a time in which any of the interactions occurred. Specifically, in such a variation at least one of the properties on which the computation of stage 650 is based is not related to any of the following:
a. a time at which any of the interactions occurred;
b. time passed between any two of more of the interactions of the series;
c. time passed between any of the interactions to another event or point in time;
d. relation of order between any two or more of the interactions of the series.

It is however noted that while not necessarily so, some of the properties of the interactions on which stage 640 is based may nevertheless be related to time (e.g., in addition to other properties such as the type of channel over which one or more of the interactions occurred).

Referring to the examples set forth with respect to the previous drawings, stage 640 may be carried out by performance assessment module such as performance assessment module 235. As will be discussed below in greater detail, the computation of stage 640 may be based on various types of properties—each pertaining to a single interaction or to more than one interaction. Additionally, the computing of stage 640 may be based on additional information other than the properties which relate to the at least one interaction.

The interactions-related properties on which the computing of stage 640 is based do not pertain only (if at all) to the order of the interactions within the series. The computing is based on properties of the interactions such as (although not limited to) any combination of the following types of properties:
a. properties quantifying relative quality of the interaction, of types of communication or of advertisement channels used by the respective interaction;
b. properties of at least one subset of interactions of the series, the subset including multiple interactions (e.g., combinations—i.e., ordered or unordered sequences—of interactions of different types; amount of interactions of a given type in the entire series, temporal relations between interactions (generally or these of predefined types, etc.);
c. properties of elements that triggered interactions of the series (e.g., of a keyword in an interaction that involves keywords, e.g., the length of that keyword, whether such keyword includes or otherwise pertains to a pre-identified commercial brand or other advertised entity or not, etc.).
By way of example, such keywords may indicate a type or classification of the conducted search (which involved the keywords). Such typing may refer to the scope of the search (whether this search was relatively broad/generic, e.g., a search for “cellular phone” relatively narrow/specific, e.g., a search for “Samsung Galaxy S3”). Another typing may pertain to the assumed purpose of the search (e.g., resembling a search in an index, for finding a known website, or for finding previously unknown information; navigational/non-navigational search);
d. properties which pertain to the creative media used in an advertisement involved in at least one of the respective interactions (e.g., copy, size, content, images, videos);
e. properties which pertain to an advertised entity associated with the interaction (e.g., properties pertaining to a commercial company, a brand, a product, a service, etc.);
f. properties which pertain to an advertisement provided to a user in the interaction;
g. properties which pertain to an estimated phase of a process-to-conversion model to which the interaction belongs (e.g., attention; interest; desire; action);
h. properties of the series of interactions which pertain to the order in which interactions of different types are ordered;
i. properties of the series of interactions which pertain to elapsed time between the interactions and between the interactions and conversions;
j. properties of the user, i.e., the ‘interactor’ (e.g., its personal characteristics, its location etc.);
k. properties of the platform used for the interaction (e.g., a mobile device, a desktop etc.)

As discussed below in greater detail, while the computing of stage 640 may be based on the properties of individual interactions of the series, it may also be based on patterns of such properties across the series of interactions.

The computing of the performance assessment in stage 640 may be used for different uses, in different implementations of the invention. Possibly, the computing of stage 640 may enable efficient utilization of communication resources, and/or of other types of resources. This efficient utilization of resources (and especially of the communication resources) may be part of method 600, but this is not necessarily so. Such communication resources may include, for example, any combination of one or more of the following: advertising resources, communication hardware resources, communication channel resources, and so on). It is noted that method 600 may be implemented as a computerized prediction method for assessing an optional future conversion of a selected user based on a history of interactions with the selected user, that method includes executing by a processor: (a) obtaining information pertaining to interactions with the selected user which are included in a series of user interactions associated with the selected user, wherein at least one of the interactions of the series includes communication of digital media over a network connection; and (b) computing a conversion assessment for the series of interactions, based on the obtained information and on an assessment scheme which is based on a statistical analysis of historical data of a plurality of series of interactions; wherein the conversion assessment pertains to the optional future conversion of the selected user which is valuable to an advertiser whose digital media was communicated to the selected user in at least one interaction of the series.

It is noted that stage 640 may include computing of multiple performance assessments, each of which is determined based on a different combination of obtained information and assessment scheme (which is based on a statistical analysis of historical data of a plurality of series of interactions). That is, the different performance assessments may be computed based on different assessment schemes, based on different portions of the information obtained in stage 610 (and/or on different processing of information obtained is stage 610), or based on data differing in both of these manners.

For example, based on a single series of interactions (of which information is obtained in stage 610), multiple performance assessment may be computed. Different performance assessment may be computed for example:
a. For different types of performance (e.g. for different types of conversions, for estimating expected costs until a conversion);
b. Based on different assumptions regarding future events (e.g. based on different estimations regarding costs of future interactions with the user, estimating the cost to conversion);
c. Based on different assessment criteria (e.g. likely performance assessment” vs. “worst case” assessment);
d. Assuming different future interactions (e.g. given a past series of events, assessing the likelihood of attaining a conversion for each one out of possible future advertisements that may be presented to the user);
e. Other factors.

This may also be regarded as reiterating stage 640. All the variations discussed with respect to stage 640 (or to stages based on its results) may be implemented for any one or more out of multiple such instances of computing, if implemented.

While the performance assessment may be an assessment of the likelihood that the series would lead to a conversion (or a conversion-rate assessment), the performance assessment may have different meanings in different implementations.

In Internet marketing, conversion rate is the ratio of visitors who convert casual content views or website visits into desired actions based on subtle or direct requests from marketers, advertisers, and content creators. Examples of conversion actions might include making an online purchase or submitting a form to request additional information. The conversion rate may be defined as the ratio between the number of goal achievements (e.g. number of purchases made) and the visits to the website (which may have resulted from ads displayed in response to the specific keywords). For example, a successful conversion may constitute the sale of a product to a consumer whose interest in the item was initially sparked by clicking a banner advertisement.

The performance assessment may also be an assessment of the number of future interactions expected before a conversion is reached (or even before a valid estimation that a conversion may be/may not be expected is reached), of the time before a conversion (or like estimation point) is reached, of the cost before a conversion (or like estimation point) is reached, an assessment of the revenue from the conversion (e.g. which products is the user likely to end up buying), etc.

As aforementioned, the computing of the performance assessment in stage 640 is based not only on the obtained information which pertains to interactions of the series, but also on an assessment scheme (which may be a “calibrated assessment scheme”). The assessment scheme on which the computing of stage 640 may optionally be based may be implemented in different ways. An assessment scheme is a set of one or more rules according to which the performance assessment may be computed, based on information pertaining to interactions of the series. Some assessment schemes which may be implemented may include simple rules (e.g., “the process assessment is equal to a portion of the interactions of the series which are associated with a brand related keyword”), while other possible assessment schemes may include substantially more complex rules (e.g., as discussed below). While some assessment schemes may be strictly deterministic, other may include some random or semi-random aspects.

In addition, an assessment scheme may be determined by an expert, regardless of any specific statistical data, or based (solely or partly) on statistics of historical interactions logs. An example of the former is the previously mentioned example in which prior art order-based attribution-scheme in which an expert may determine that the process assessment is equal to a portion of the interactions of the series which are associated with a brand related keyword.

A calibrated assessment scheme is an assessment scheme which is based on an analysis (e.g., a statistical analysis, possibly also linguistic analysis, etc.) of historical data which includes multiple series of interactions. Optionally, the historical data which is analyzed for the generation of the calibrated assessment scheme may also include the historical outcomes of some or all of these series (e.g. which of these series ended up in a conversion and which didn't, what was the physical dimensions of the output product in each of these series, and so on). The calibrated assessment scheme is calibrated in that it is pertains only to series of interactions which fulfill a selection condition, and is used only to series of interactions which fulfill the same selection condition.

For example, the following calibrated assessment schemes pertain only to series of interactions which fulfill the following conditions:
a. Series of interactions which are associated with a certain advertiser.
b. Series of interactions which are associated with a certain country or jurisdiction.
c. Series of interactions which are associated with a certain line of products of a given advertiser.
d. Series of interactions which are associated with a certain vertical.

Furthermore, the calibrated assessment scheme may be an assessment scheme which is based on an analysis of partial historical data (i.e., not of all of the available historical data) which is selected out of a larger log of historical data based on compliance of the selected series (and/or interactions) with one or more such selection rules.

For example, a log of historical data which pertains to a single advertiser may be divided based on the line of product (e.g., cellular phones vs. televisions), and each of these parts may be used for the generation of a respective calibrated assessment scheme. Afterwards, a performance assessment for a series of interactions which is associated with televisions (e.g., a conversion in which a television was purchased online) would be computed based on the assessment scheme calibrated based on the television-related historical data, while a performance assessment for a series of interactions which is associated with cellular phones (e.g., a conversion in which a charger for an iPhone™ cellular phone was purchased online) would be computed based on the assessment scheme calibrated based on the cellular-phones-related historical data.

It is noted that the calibrated assessment scheme may be updated from time to time based on new historical data. That is, method 600 may further include repeatedly updating the calibrated assessment scheme (at regular intervals or otherwise), wherein each updating is based on historical data which is more recent than any of the previous instances of updating (that is, at least some of the historical data on which such updating is based is more recent than any of the previous instances of updating).

It is noted that this way, method 600 may be used for building and utilizing a calibrated assessment scheme that is unique to an advertiser, for computing performance assessment to relevant series of user interactions. Such a method would include executing by a processor: (a) analyzing historical data of a plurality of series of interactions with a plurality of users, each of the plurality of series including at least one interaction which is associated with the advertiser; (b) determining the calibrated assessment scheme based on results of the analyzing (e.g., by determining weights such as in stage 670); and (c) computing a performance assessment for a series of user interactions, at least one of which is associated with the advertiser, according to the previously discussed stages of method 600.

The analysis of the historical data may reflect, for example, causal relationship between interactions (interactions causing other interactions) and causal relationship between interactions and conversions. It is noted that the analysis may include analysis of series which did not contain conversions.

Method 600 may include stage 650 of updating a database entry based on the performance assessment computed in stage 640. Referring to the examples set forth with respect to the previous drawings, stage 650 may be carried out by a database such as database 275, or by a database management module (not illustrated) implemented on a processor such as processor 225. It is noted that the updating may include a stage of processing the computed performance assessment (and possibly additional data) to determine the new value for the database entry.

The updating of stage 650 may include updating a database entry associated with one of the plurality of interactions, a database entry associated with one of the interaction properties which are used in the computing, a database entry associated with a pattern of one or more properties across a group of interactions, etc. Such a process of updating may be repeated for more than one of the above (e.g., more than one interaction, more than one pattern, more than one property, and any combination of the same).

For example, the updating may include updating assessments of a potential contribution of a type of interaction to the realization of a future event. For example, one or more of the following entry types may be updated, pertaining to one or more interactions types, one or more pattern types, one or more property type, etc.:
a. An assessment of the likelihood that an interaction of the respective interaction type would lead to a conversion;
b. An assessment of the likelihood that an interaction of the respective interaction type would lead to an interaction of another type (e.g., the likelihood that a search-engine originated interaction would lead to a social-network based interaction).

Optionally, stage 650 may include updating an entry which pertains to a sequence of interactions, or to a sequence of interaction types. For example, one or more of the following entry types may be updated, pertaining to a sequence of interactions of one or more interaction types:
a. An assessment of the likelihood that a sequence of interactions of one or more interaction types (e.g., an interaction pertaining to advertiser's brand followed by two interactions which do not pertain to that brand; three interactions within one hour, etc.) would lead to a conversion.
b. An assessment of the likelihood that a pattern occurring in at least one property of the interactions across a subgroup of some or all of the interactions of the series which are of one or more interaction types (e.g., an interaction pertaining to advertiser's brand followed by two interactions which do not pertain to that brand; three interactions within one hour, etc.) would lead to a conversion
c. An assessment of the likelihood that that a sequence of interactions of one or more interaction types would lead to an interaction of a known type.

Generally, it is noted that one interaction may lead to another and that this other interaction may lead to a conversion. For example, an interest aroused in the client by a display ad may lead the customer to later search for the advertiser's site using a search engine. In other scenarios, two interactions in a series may be completely unconnected. Stage 650 may be implemented for detecting and/or for reflecting whether there is a causal relationship between interactions (or interaction types), and in cases where such causality does exist assign credit to both indirect and direct players in the conversion path.

That is, optionally method 600 may include statistically analyzing historical data of a plurality of series of interactions with at least one user for detecting one or more causal relationships between different interaction types (i.e., if an occurrence of one or more of these interactions type indicates high likelihood that interaction of another one of these interaction types would occur), based on an analysis of the historical data, and updating the assessment scheme so that both direct and indirect interactions in the series would contribute to the computation of the performance assessment, thereby reflecting the detected causal relationship (i.e., to interactions contributing to the conversion directly and to interactions contributing to the conversion indirectly).

In addition to causality, the updating of stage 650 may also be implemented for detecting and/or reflecting synergy. A customer looking to buy a television may be influenced by the paid search ads that appear and that they clicked on while searching for a specific model using a search engine. They could also be influenced by seeing an ad on a social networking site such as Facebook that reports that one or more of their friends “likes” a certain online electronics store. But the combined influence of seeing the same store come up in both the paid search ads and on Facebook may be larger than the influence of each of those individual engagements. The updated entries may later be used so that such synergies are detected and so that the performance assessment would be computed appropriately when they occur.

That is, optionally method 600 may include statistically analyzing historical data of a plurality of series of interactions with a plurality of users for detecting synergy between different types of interactions, wherein the computation of the performance assessment is based on the detected synergy. The detecting of such synergy may be a part of the statistical analysis which serves for the determination/updating of the calibrated performance assessment module (if implemented), and the utilizing of the synergy in the computing may in such case be a result of utilizing the calibrated assessment scheme which reflects the detected synergy. The detection of the synergy may be explicit or implicit (i.e., the method may include detecting such synergy even if such synergy is not explicitly pointed out as “synergy”).

Method 600 may also include stage 660 of communicating with one or more users, based on the computed performance assessment. Referring to the examples set forth with respect to the previous drawings, stage 660 may be carried out by a communication module such as communication module 285. The communicating of stage 660 may include providing advertisements to the one or more users, or providing other information, and may also include receiving information from such one or more users.

The efficient utilization of communication or advertising resources (e.g., as part of stage 660) may be a result of utilizing the aforementioned database for future communication with the client, and especially using one of the entries updated at optional stage 550, based on the computation of stage 540.

For example, the efficient utilization of communication resources (which may include advertising resources, communication hardware resources, communication channel resources, and so on), enabled by the computing of stage 640 may include reducing an amount of data communicated to the user, thereby reducing an amount of communication resources. For example, parameters of the user, and/or of a posterior possible interaction with the user may be analyzed based on the results of the computing (e.g., based on the database referred to in the context of stage 650). If a result of the analysis is that a given interaction with the user at that opportunity should be limited or altogether avoided, a clear reduction in communication costs (financial, datalink, processing power, etc.) is obtained.

Efficient utilization of communication or advertising resources may also be achieved by better targeting the user with targeted advertising in view of the computed performance assessment (e.g., based on the database referred to in the context of stage 650).

Another example of utilization of advertising resources may be changing elements which are involved in an interaction, as changing a keyword which was involved in a search engine marketing (SEM) campaign in view of the results of the computing of stage 640. Yet another example of utilization is changing inputs to other mechanisms and systems that interact or otherwise connect to the interaction, as changing the bid with respect to keywords that are involved in a search engine marketing (SEM) campaign in view of the results of the attribution.

It is noted that in addition to regular uses of the term “efficiency” and its derivative forms (e.g., “efficiently”), the term as used herein should be expansively construed to cover ways of putting the relevant resources into good, thorough, and/or careful use, especially regarding the utilization of these resources (thereby consuming a relatively small amount of such resources for providing a desirable outcome).

Reversion is now made to stage 640 and to the various kinds of properties which may be used in the process of computing the performance assessment.

Optionally, the computing may include computing the performance assessment based on properties quantifying relative quality of the interactions. While different types of interactions (e.g., e-mails, telephone conversations, electronic advertisements, social media interactions, paper advertisements, videos watched, etc.) may be qualified by different types of quantities, many such quantified properties used for assessing quality of the interactions may be implemented, and in fact a significant variety is already used in the art. Offering only a few examples, such properties quantifying relative quality of the interactions may include:
a. Duration of the interaction (e.g., time spent on website, duration of a phone conversation, percent of video length watched by the user, etc.);
b. Amount of data transferred to the client during the interaction (e.g., amount of web pages viewed);
c. Engagement of the user in the interaction (e.g., view, mouse-over, click in, click out)

Such properties quantifying relative quality of the interactions may also quantify relative quality of a group of interactions (e.g., interactions of the same type). For example, statistic products of the above example properties (e.g., minimum, maximum, average, median, mean, standard deviation, etc.). Other examples include:
a. Parameters qualifying response of user (or users) to such interactions (e.g., bounce rate);
b. Redundancy in interactions (e.g., times in which the interaction resulted from the same keyword entered by the user);

Optionally, the computing may include computing the performance assessment based on properties of at least one keyword entered by a user which triggered at least one interaction of the series.

Optionally, the computing may include computing the performance assessment based on properties which pertain to an advertisement provided to a user in at least one of the interactions of the series. Such properties pertaining to such an advertisement may be, for example, the type of the advertisement (e.g., video, non-video, image, animated-gif, text, etc.), duration of the advertisement, size of the advertisement (in centimeters, in pixels, etc.), an affectivity score of the advertisement (e.g., based on prior success/attribution analysis), its source (e.g., being sent from a friend, being included in a social-media feed, etc.), and so on.

Optionally, the computing may include computing the performance assessment based on types of communication channels used by the respective interactions. The types of communication may be analyzed in different resolutions. By way of example, a very coarse resolution is machine interactions vs. human interactions. A finer resolution would be the interactions technology used (e.g., e-mail, video, text ad, social-media, telephone, billboard). A yet finer resolution would differentiate, for example, between video advertisements embedded in an external website to video streamed at the website of the publisher, contextual display advertising, paid/non-paid advertising, and so on.

Optionally, the computing may include computing the performance assessment based on properties of elements that triggered interactions of the series. Interactions may be triggered by actions of the user who is a party of the interaction (e.g., by entering a keyword into a search engine), by the marketer (e.g., by sending a newsletter and/or an advertisement to a mailing list of users), or by actions of another user.

The properties pertaining to such elements (or events) may be, for example, parameters of the keyword entered (e.g., its length) or other element involved in the interaction, demographic parameters of a user (e.g., age, gender), and may also be meta-parameters such as—does the keyword include a brand-name of the marketer, does the keyword include a specific product name, manufacturer or model etc. Parameters which pertain to the event which triggered the interactions may be time of the event (e.g., the time of the day in which the keyword was entered by the user), the location of the event, etc. It should be noted that while not necessarily so, the event which triggered the interaction may be another interaction (which may be part of the series, but not necessarily so).

Optionally, the computing may include computing the performance assessment based on properties of at least one keyword entered by a user which triggered at least one interaction of the series.

Optionally, the computing may include computing the performance assessment based on properties which pertain to an advertised entity associated with one or more interactions of the series of interactions. The advertised entity may be the marketer itself (for example, such a property is: whether the keyword includes the brand-name of the marketer), and may also be an advertised product or a service.

By way of example, the user may have ultimately purchased a certain type of product (say, a DELL computer). In view of this, advertisements which were presented to this user and which advertised totally unrelated products (e.g., shoes, razor blades, etc.) may be attributed smaller apportionments than advertisements (or other types of interactions) which are more relevant to the advertised entity (e.g., ones pertaining to computers, electronic gadgets, other DELL products, etc.).

Optionally, the computing may include computing the performance assessment based on properties of at least one subset of interactions of the series, wherein the subset includes multiple interactions. The subset of interactions may be defined in different ways.

For example such properties of a subset of interactions may include:
a. Duration between two (or more) interactions of the subset;
b. Causal relations between two (or more) interactions of the subset;
c. Patterns occurring in at least one property of the interactions across the subset of interactions (e.g., considering the property Brand (B) vs. Non-Conversion (NB) as a type of a single interaction, the property of the subset may be defined is whether the pattern NB-NB-NB-B occurs in the ordered subset);
d. The number of users that were a party to at least one of the interactions (and possibly the number of interactions having at least a predefined number of users participating therein);

It should be noted that the subset may be a proper subset of the series of interactions (i.e., include a smaller number of interactions), but in other alternatives it may include the entire series of interactions. Using the terminology of a path of interactions (also referred to as “conversion funnel”, “Path to conversion” or P2C, where applicable, or possibly also just as “Path”), the computing may include computing the performance assessment based on patterns occurring in at least one property of the interactions across the series of interactions, i.e.,—across the path.

As aforementioned, the computing of the performance assessment in stage 640 may be based on patterns which may be detected in the series of interactions.

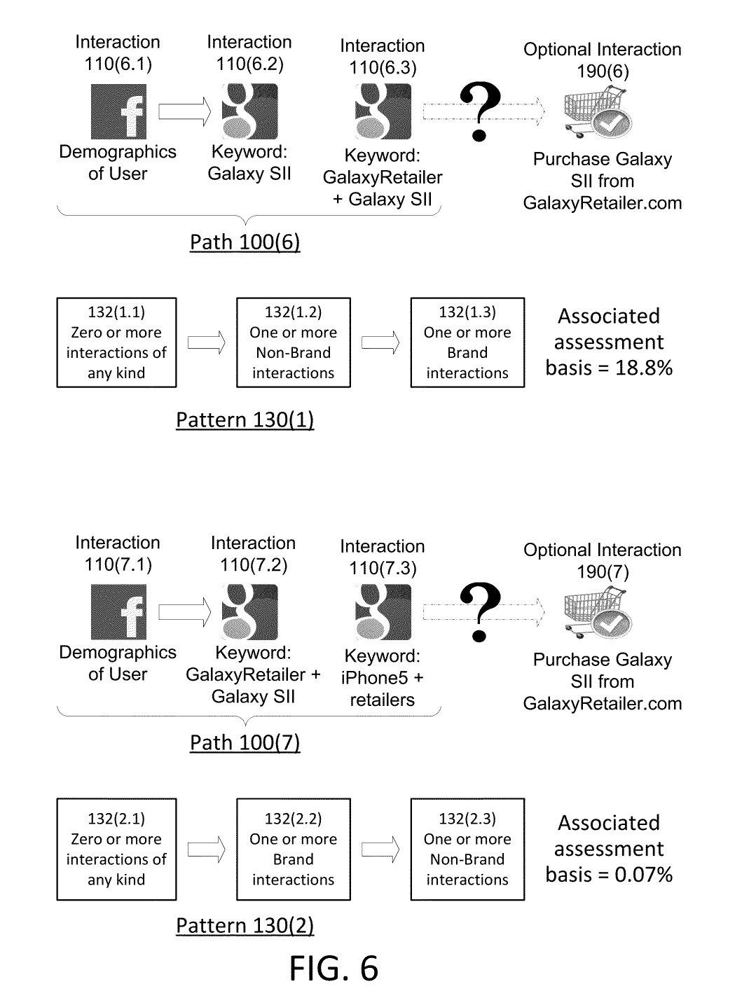

FIG. 6 illustrates two series of interactions, 100(6) and 100(7), each including three interactions, as well as two patterns 130(1) and 130(2), according to an embodiment of the invention.

The first of these series, series 100(6), includes: (1) a first interaction 110(6.1) in which the user reacted to an advertisement provided within a social network in response to the demographics of the users, followed by (2) a second interaction 110(6.2) in which the user reacted to an advertisement provided within a search engine in response to a general query entered by the user (not including a name of the advertiser, which in this case is assumed to be a retailer named “GalaxyRetailer”); followed by (3) a third interaction 110(6.3) in which the user interacted with an advertisement provided within a search engine in response to another search query entered by the user, in which the user indicated the name of the advertiser (as well as a specific product).

The second of these series, series 100(6), includes: (1) a first interaction 110(7.1) in which the user reacted to an advertisement provided within a social network in response to the demographics of the users, followed by (2) a second interaction 110(7.2) in which the user reacted to an advertisement provided within a search engine in response to a search query entered by the user, in which the user indicated the name of the advertiser (as well as a specific product); followed by (3) a third interaction 110(7.3) in which the user interacted with an advertisement provided within a search engine in response to another search query entered by the user (not including a name of the advertiser, and indicating another product than the one associated with previous interactions with that user).

The performance assessment which is to be computed for each of these series is, in the illustrated example, the likelihood of a conversion in which the user will purchase the respective product through the website of the advertiser GalaxyRetailer.com.

In the illustrated example, series 100(6) matches a first pattern, pattern 130(1), which ends with one or more interactions which are not associated with a brand-name of the advertiser, followed by one or more interactions which are associated with this brand-name. Likewise, series 100(7) matches a second pattern, pattern 130(2), which ends with one or more interactions which are associated with a brand-name of the advertiser, followed by one or more interactions which are not associated with this brand-name.

One or more values, hereinbelow referred to as “assessment basis”, is associated with each of the patterns, and may be used in the computing of the performance assessment. However, as discussed below in more detail, the performance assessment computed for a series is not necessarily identical to the assessment basis associated with a pattern to which the series matches.

Referring to the example of FIG. 3B, stage 640 may include stage 642 of matching the series to one or more patterns out of at least predefined patterns, based on the obtained information, and stage 644 of determining the performance assessment for the series based on assessment basis information which is associated with the one or more matching patterns.

The predefined patterns from which the matching patterns are selected may be defined in many ways. For example, the patterns may be defined as ordered sets of groups of interactions (denoted 132), wherein each group includes a number of interactions (the number may be within a predefined range) whose properties fill at least one selection criterion. Such patterns are exemplified by patterns 130(1). It is however noted that each group of patterns (132) may be defined by criterions relating to more than one property type. Furthermore, the groups 132 in such definitions of patterns may be partly overlapping.

It is noted that some series of interactions may be matched to more than one pattern. For example, any of series 100(6) and 100(7) also match a pattern which ends with one or more interactions which are initiated in a social-network context, followed by two or more interactions which are triggered in a search engine context, wherein at least one of these two or more interactions is associated with a brand-name of the advertiser.

Reverting to stage 644 which includes the determining of the performance assessment for the series based on assessment basis information which is associated with the one or more matching patterns. It is noted that while the assessment basis is exemplified by a percent (indicative of likelihood), it is not necessary that the assessment basis would be a percent, and it is not necessary that the assessment basis would even be given in units or sizes which are directly translatable to a performance assessment. For example, the assessment basis may be a class, or parameters of an assessment scheme.

The determining of the performance assessment in stage 644 is based, as aforementioned, on the assessment basis information, but it may also depend on additional information, such as the information obtained in stage 610. Referring, for example, to series 100(6) and to pattern 130(1), the determining may include modifying the assessment basis of 18.8% based on other parameters such as the size of the advertisements provided to the user in one or more of the interactions, or to any other one or more properties selected from property types such as:
a. Properties quantifying relative quality of the interactions;
b. Types of communication channels used by the respective interactions;
c. Properties of at least one subset of interactions of the series, wherein the subset includes multiple interactions;
d. Properties of elements and/or events that triggered interactions of the series;
e. Properties which pertain to an advertised entity associated with the interaction;
f. Properties of at least one keyword entered by a user which triggered at least one interaction of the series;
g. Properties which pertain to an advertisement provided to a user in at least one of the interactions of the series;

or any of the other property types mentioned above.

Reverting to stage 660 which includes communicating with one or more users (possibly other users than the one or more which were parties to the interactions of the series). Information about such later communication may be obtained at a later reiteration of stage 610, and the method may be repeated. It should be noted that different stages of computing may be based on different assessment logic and/or parameters; especially if those parameters and/or logic are based on the result of the computing (stage 640) or of posterior communication (stage 550), but also in other situations.

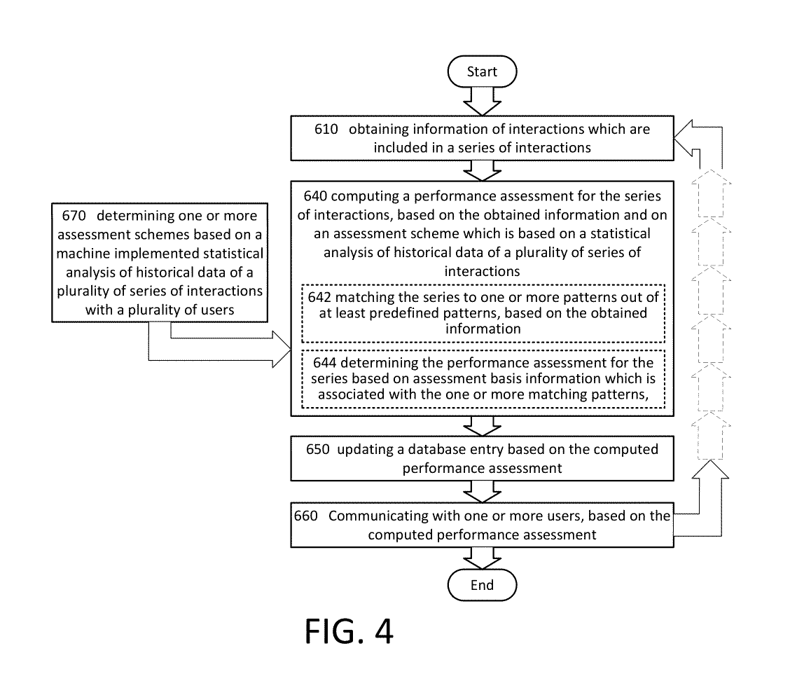

FIG. 4 illustrates method 600 according to an embodiment of the invention. It is noted that the computing of the performance assessment in stage 640 may be based, as aforementioned, on properties relating to at least one interaction out of the series of interactions.

Method 600 may include optional stage 670 of determining one or more assessment schemes based on a machine implemented statistical analysis of historical data of a plurality of series of interactions with a plurality of users. Referring to the examples set forth with respect to the previous drawings, stage 670 may be carried out by an assessment scheme processing module such as assessment scheme processing module 265. The computing of the performance assessment in stage 640 may be based in such cases on one or more of the at least one assessment scheme determined based on the statistical analysis of the historical data of the plurality of series of interactions with a plurality of users.

That is, method 600 may include statistically analyzing the historical data of the plurality of series of interactions, and determining the assessment scheme (and possible alternative assessment schemes as well) based on a result of the analyzing.

The statistical analysis of stage 670 may be executed for detecting synergy between different types of interactions, wherein the computing of the performance assessment is based on the detected synergy.

Stage 670 may include, for example, determining a weight and/or an assessment basis for each property out of a plurality of properties of sets of interactions (and/or for each pattern out of a plurality of patterns of sets of interactions), wherein the determining of the weight or assessment basis is based on frequencies of patterns of interactions having said properties. Such sets may include sets including a single interaction each, and/or sets that include more than one interaction each.

Stage 670 may also include, for example, determining the assessment schemes based on relative success rates of sets of interactions which possess a given property and/or pattern, with respect to success of other sets of interactions.

Said properties may include, for example:
a. Properties quantifying relative quality of the interactions;
b. Types of communication channels used by the respective interactions;
c. Properties of at least one subset of interactions of the series, wherein the subset includes multiple interactions;
d. Properties of elements and/or events that triggered interactions of the series;
e. Properties which pertain to an advertised entity associated with the series of interactions;
f. Properties of at least one keyword entered by a user which triggered at least one interaction of the series;
g. Properties which pertain to an advertisement provided to a user in at least one of the interactions of the series;
h. Patterns occurring in at least one property of the interactions across the series of interactions.

Optionally, the statistical analysis of stage 670 is based on relative success of sets of interactions having certain patterns of interactions with respect to success of other sets of interactions having other patterns of interactions.

It is noted that stage 670 may be repeated from time to time. That is, method 600 may include repeatedly updating the assessment scheme, wherein each updating is based on historical data which is more recent than any of the previous instances of updating. Referring to method 600 as a whole, it is noted that method 600 may be implemented as a computerized prediction method for individual users based on user interactions history. Based on a series of interactions which is relevant to a single selected user, the performance assessment may be computed with respect to that user. For example, the chances that a series of interactions with the selected user may yield to a purchasing of a product, the expected revenue from such a transaction, and so on, may be calculated based on a series of multiple interactions.

It is noted that this computation may, in some implementations, be based also on information of interactions with other users, e.g. of another user which entered an e-mail of the selected user so that an advertisement or a greeting card will be sent to the selected user.

The series of user interactions in such cases is therefore associated with the selected user, and at least one of the interactions of the series includes communication of digital media over a network connection to the selected user.

The computing would include computing the performance assessment for the series of interactions associated with the selected user, that computing being based on the obtained information with respect to the specific user and on the assessment scheme.

Optionally, the computing may be based on properties relating to at least one interaction out of the series of interactions, wherein the properties include properties of at least one subset of interactions of the series (the subset includes multiple interactions) and at least one property out of the following types: (a) properties quantifying relative quality of the interactions, (b) types of communication channels used by the respective interactions.

The performance assessment computed in stage 640 may pertain to an optional future interaction with the selected user which is valuable to an advertiser whose digital media was communicated to the selected user in at least one interaction of the series.

Some use cases will now be presented, by way of non-limiting examples.

Method 600 may be used, for example, for lead generation.

Lead generation is a process of generating consumer interest or inquiry into products or services of a business, especially in Internet marketing. Leads may be generated in various ways such as advertising, organic search engine results, referrals from existing customers, etc. Such leads, however, differ in their quality (the likelihood that value will be generated for the advertiser from the user to which the leads point, and the expected value). Quality is generally indicative of the propensity of the inquirer to take the next action towards a purchase or another type of conversion.

The performance assessment computed in stage 640 may be indicative of these very properties, and therefore the quality of each selected user as a lead may be determined. This information may be used by the party who collects the information in stage 610, and may also be monetized by selling quality leads to a third party. Computing of multiple performance assessment for determining to which third party this path will be of greater value may enable to select the third party more efficiently and/or profitably.

Method 600 may further include assigning a value to the series based on the performance assessment. For example, based on the likelihood of conversion of the series, a price (i.e. the value in that case), may be determined in which this lead will be sold to a third party.

When method 600 is used for lead generation, the lead generation process may include: assigning to each out of multiple series of interactions (each of the series being associated with a different user) a value according to the above disclosed method of value assignment (thereby assigning different values to the different users associated with the respective series), and exchanging contact details of the different users with a third party in return for transactions by the third party whose content is determined in response to the values assigned to the different users. The return transactions may be transactions of money (be it a legal tender, an electronic currency, etc.), but this is not necessarily so, and the returning transactions may also be transactions of physical goods, of material, of information, and so on.

A method for lead generation may also be implemented by: (1) assigning different values to the different users associated with multiple respective series of interactions, by executing for each out of multiple series of interactions, each of the series being associated with a different user: (a) computing a respective performance assessment for the series of interactions according to method 600, and (b) assigning a respective value to the series based on the respective performance assessment; and (2) exchanging contact details of the different users with a third party in return for transactions by the third party whose content is determined in response to the values assigned to the different users.

Method 600 may be used for real time bidding (RTB) and for communication with RTB servers, for example, by performing the following process:
a. Executing stage 610, 620, 630 and 640 for each out of a multiple series of interactions, each of these multiple series includes at least one interaction which complies with a predefined criterion. This executing of stage 610, 620, 630 and 640 results in computing for each of these series a performance assessment which is an assessment of an optional future conversion to which that series of interactions may lead.
b. based on the computed performance assessments, updating a value assignment parameter (examples of which are given below); and
c. selectively initiating a communication of digital media which complies with the predefined criterion, wherein the selective initiation of the communication includes bidding on an advertisement, wherein a magnitude of the bidding is based on the value assignment parameter.

Such a predetermined criterion may be, for example, the product advertised, the size of the advertisement, and any one of the aforementioned properties. It is noted that more than one criterion may be used.

Real Time Bidding (RTB) takes place when a user visits a website which includes advertisements, upon which a call is made by a respective Real Time Bidding server to Demand Side Platforms (DSP) or to Ad Networks (Ad Exchange). Based upon the results of these addressees, the RTB server may determine which advertiser gets to serve the ad. Each user has an associated set of attributes, which is transferred from the RTB server to the DSPs, which may then determine whether the user has attributes which the relevant advertiser wants to target. Based on the perceived value of this user (determined in stage b above, for example), a bid is placed on this ad impression by relevant advertisers (thereby initiating stage c). The selection of the advertisement may be based, for example, on the highest bid.

The determining of which bid to place for a specific user at a specific time may be based on the conversion rate of advertisement of the advertiser which complies with such a predetermined criterion. While the estimation of the conversion rate should preferably be as up to date as possible (which requires the use of the most recent data, such as clicks from the last week), some conversions only happen up to several weeks after the click. Therefore, it is not yet known whether the series which included interactions from the last week would yield a conversion or not, and therefore the recent data is partial. Executing the process described above allows predicting the conversion rate based on clicks/paths that have not yet converted but are likely to do so.

Method 600 may be used for inventory management, for example, by performing the following process:
a. Executing stage 610, 620, 630 and 640 for each out of multiple series of interactions, each of these multiple series includes at least one interaction which complies with a predefined criterion. This executing of stage 610, 620, 630 and 640 results in computing for each of these series a performance assessment which is an expected magnitude of an optional future transaction to which that series of interactions may lead;
b. based on the computed performance assessments, determining an expected overall magnitude of multiple optional future transactions (e.g. by determining an expected inventory of at least one item to be transacted in the optional future transactions); and
c. selectively initiating a communication of digital media which complies with the predefined criterion, based on the expected overall magnitude (e.g. by selectively initiating a communication of digital media which complies with the predefined criterion, based on the expected inventory).

If there is a limited inventory of a product or a service (e.g. leads, cars, insurance policies), there is a need to estimate how much of the inventory has already been sold or should be considered as sold (including conversions that have occurred and such which will occur before the end of the inventory cycle) in order to decide whether and at what pace to continue to invest in communication with users (e.g. by Internet marketing such as search engine marketing, SEM).

Utilizing method 600 as described above enables to aggregate data of many users. Based on the conversion estimation of many users, it is possible to determine how many products are likely to be sold. It is noted that the magnitude may be a conversion rate (especially in cases in which in each conversion only a single product is sold), but may also be indicative of the value and/or amount of product sold in each conversion.

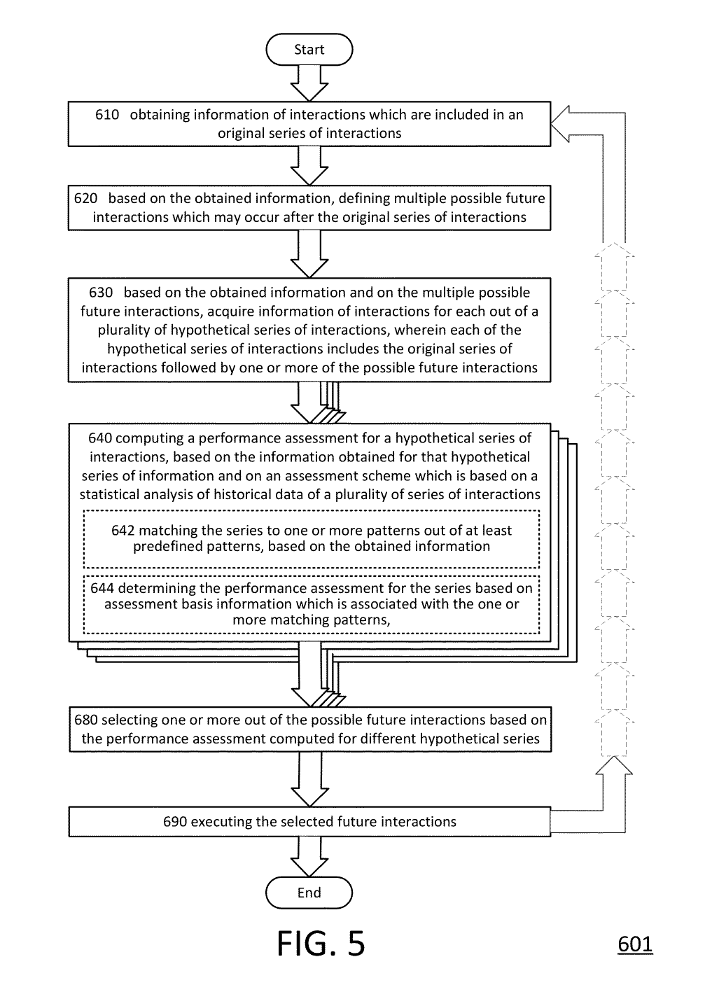

Method 600 may be used for retargeting, for example, by performing the process illustrated in FIG. 5. Behavioral retargeting (also known as behavioral remarketing, or simply, retargeting) is a form of online targeted advertising by which online advertising is targeted to consumers based on their previous Internet actions, especially (though not necessarily) in situations where these actions did not result in a sale or conversion.

For any given user, implementing of method 601 enables to assess the impact which different advertisements (or other actions), when communicated to the user, will have on his chances to convert. This may enable to decide whether and how much to bid to show him each of the ads in which digital media is included, and possibly to select which one or more ads to bid on.

FIG. 5 illustrates method 601, according to an embodiment of the invention. Method 601 includes the stages of method 600 (among other stages), and all variations which are discussed above with respect to method 600 are also applicable for method 601.

The series whose information is obtained in stage 610 is referred to, in the context of method 601, as “the original series”, thereby differentiating it from other hypothetical series which are generated on its basis.

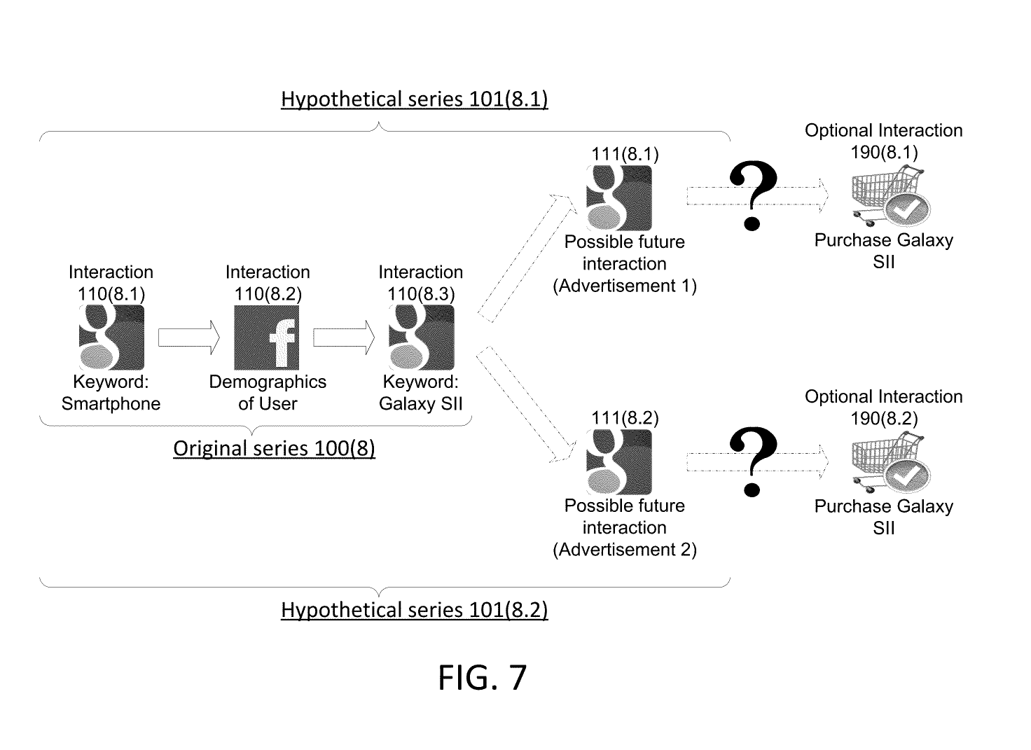

Following stage 610, method 601 includes stage 620 which includes defining multiple possible future interactions which may occur after the original series of interactions, based on the obtained information. The multiple possible future interactions defined (interactions 111(8.1) and 111(8.2) in FIG. 7) need not include all of the possible future interactions, but rather several interactions (e.g. such which past experience suggest that may yield a favorable result). The selection of the possible future interactions in stage 620 may be based on the properties of the interactions in the original series (100(8) in FIG. 7), on patterns within the original series, and possibly on additional data (e.g. data regarding the user, data regarding an advertisement campaign, data regarding costs of such possible future interactions, etc.). The multiple possible future interactions defined may include, for example, different types of advertisement and/or advertisement transmitted over different types of channels.

Method 601 continues with stage 630 in which, based on the obtained information and on the multiple possible future interactions, information of interactions is acquired for each out of a plurality of hypothetical series of interactions, wherein each of the hypothetical series of interactions includes the original series of interactions followed by one or more of the possible future interactions. In the example of FIG. 7 the hypothetical series are hypothetical series 101(8.1) and 101(8.2). It is noted that a hypothetical series may include more than one possible future interaction. The information obtained in stage 630 may include, for example, additional information such as information regarding an event which triggered the execution of method 601 (e.g. an advertisement may be emailed to the user in response to a triggering event).

Method 601 continues with executing stage 640 for each out of the multiple hypothetical series, computing for each of them a performance assessment, which is followed by stage 680 of selecting one or more out of the possible future interactions based on the performance assessment computed for different hypothetical series, and possibly on additional data (e.g. estimated cost of implementing the different alternatives). For example, if the performance assessment of hypothetical series A is only 1% larger than that of hypothetical series B, but the cost of executing the future interactions included in hypothetical series A is 10% larger, the future interactions of hypothetical series B may be selected.

Optional stage 690 includes executing the selected future interactions.

When method 601 is used for retargeting a selected user with an advertisement which is selected based on previous Internet interactions with the selected user, the selecting of stage 680 may include selecting an advertisement out of multiple possible advertisements, and the executing of stage 690 may include presenting the selected advertisement to the selected user.

Reversion is made to FIG. 1 and to system 205.

Optionally, system 205 may include assessment scheme processing module 265 which is configured to statistically analyze the historical data of the plurality of series of interactions, and to determine the assessment scheme based on a result of the analyzing.

Optionally, performance assessment module 235 may be configured to compute the performance analysis based on properties relating to at least one interaction out of the series of interactions, and the statistical analysis of assessment scheme processing module 265 is based on frequencies of patterns of interactions having said properties.

Optionally, the statistical analysis of assessment scheme processing module 265 may be based on relative success of sets of interactions having certain patterns of interactions with respect to success of other sets of interactions having other patterns of interactions.

Optionally, performance assessment module 235 may be configured to compute the performance assessment based on properties relating to at least one interaction out of the series of interactions, wherein the properties include at least one property which is unrelated to a time in which any of the interactions occurred (and is therefore unrelated to order of the interactions in the series as well).

It is noted that all of the types of properties and patterns discussed with respect to method 600 may also be used by system 205, and especially, that performance assessment module 235 may be configured to implement any combination of one or more of these properties and patterns.

Optionally, performance assessment module 235 may be configured to compute the performance assessment based on properties of at least one subset of interactions of the series, wherein the subset includes multiple interactions.

Optionally, system 205 enables an efficient utilization of resources (as discussed with respect to method 600). For example, system 205 may enable efficient utilization of communication resources, at least by reducing an amount of data communicated to the user, thereby reducing an amount of communication resources.

Optionally, assessment scheme processing module 265 may be configured to repeatedly update the calibrated assessment scheme (at regular intervals or otherwise), wherein each updating is based on historical data which is more recent than any of the previous instances of updating (that is, at least some of the historical data on which such updating is based is more recent than any of the previous instances of updating).

It is noted that system 205 may also be configured to implement method 601, in which case interface 215 is used to obtain the series referred to as “the original series”. Processor 225 (either by module 235 or by another dedicated module) in such a case is configured to define multiple possible future interactions which may occur after the original series of interactions, based on the obtained information (the multiple possible future interactions defined need not include all possible future interactions, but rather several interactions). This selection of the possible future interactions may be based on the properties of the interactions in the original series, on patterns within the original series, and possibly on additional data (e.g. data regarding the user, data regarding an advertisement campaign, data regarding costs of such possible future interactions, etc.).

Processor 225 in such a case is also configured to manage, based on the obtained information and on the multiple possible future interactions, acquisition of information of interactions for each out of a plurality of hypothetical series of interactions (this acquisition may involve communication over interface 215, but not necessarily so). Each of the hypothetical series of interactions includes the original series of interactions followed by one or more of the possible future interactions. In the example of FIG. 7 the hypothetical series are hypothetical series 101(8.1) and 101(8.2). It is noted that a hypothetical series may include more than one possible future interaction. The information obtained with respect to the future possible interactions may include, for example, additional information such as information regarding a triggering event, e.g. as discussed with respect to method 601 (e.g. an advertisement may be emailed to the user in response to a triggering event).

Performance assessment module 235 may then compute a performance assessment for each out of these multiple hypothetical series, and a selection module implemented on processor 225 (not illustrated) may then select one or more out of the possible future interactions based on the performance assessment computed for different hypothetical series, and possibly on additional data (e.g. estimated cost of implementing the different alternatives). For example, if the performance assessment of hypothetical series A is only 1% larger than that of hypothetical series B, but the cost of executing the future interactions included in hypothetical series A is 10% larger, the future interactions of hypothetical series B may be selected. This selection facilitates executing the selected future interactions.

It will also be understood that the system according to the invention may be a suitably programmed computer. Likewise, the invention contemplates a computer program being readable by a computer for executing method 600 discussed above, and any of its variations, as well as method 601. The invention further contemplates a machine-readable memory tangibly embodying a program of instructions executable by the machine for executing method 600 discussed above, and any of its variations, as well as method 601.

It will also be understood that the system according to the invention may be a suitably programmed computer. Likewise, the invention contemplates a computer program being readable by a computer for executing method 600 and/or method 601. The invention further contemplates a machine-readable memory tangibly embodying a program of instructions executable by the machine for executing one or more of the methods of the invention

A computer readable medium is disclosed, having computer readable code embodied therein for performing a predictive method, the computer readable code including instructions for: (a) obtaining information pertaining to interactions which are included in a series of user interactions, wherein at least one of the interactions of the series includes communication of digital media over a network connection; and (b) computing a performance assessment for the series of interactions, based on the obtained information and on an assessment scheme which is based on a statistical analysis of historical data of a plurality of series of interactions.

It is noted that the aforementioned computer readable code and programmed computer may be implemented according to any one of the variations discussed with respect to methods 600 and 601, even though not explicitly elaborated for reasons of brevity of the disclosure.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It will be appreciated that the embodiments described above are cited by way of example, and various features thereof and combinations of these features can be varied and modified.

While various embodiments have been shown and described, it will be understood that there is no intent to limit the invention by such disclosure, but rather, it is intended to cover all modifications and alternate constructions falling within the scope of the invention, as defined in the appended claims.

1. A computerized predictive method, the method comprising executing by a processor:
obtaining information pertaining to interactions which are included in a series of user interactions, wherein at least one of the interactions of the series comprises communication of digital media over a network connection; and
computing a performance assessment for the series of interactions, based on the obtained information and on an assessment scheme which is based on a statistical analysis of historical data of a plurality of series of interactions.

2. A computerized prediction method for individual users based on user interactions history, the method comprising executing the method of claim 1;
wherein the series of user interactions is associated with a selected user, wherein at least one of the interactions of the series comprises communication of digital media over a network connection to the selected user;
wherein the computing comprises: based on the obtained information with respect to the specific user and on the assessment scheme, computing the performance assessment for the series of interactions associated with the selected user;
wherein the computing is based on properties relating to at least one interaction out of the series of interactions, wherein the properties comprise properties of at least one subset of interactions of the series, wherein the subset includes multiple interactions and at least one property out of the following types: (a) properties quantifying relative quality of the interactions, (b) types of communication channels used by the respective interactions.

3. The method according to claim 1, further comprising assigning a value to the series based on the performance assessment.

4. A method for lead generation, the method comprising:
assigning different values to the different users associated with multiple respective series of interactions, by executing for each out of multiple series of interactions, each of the series being associated with a different user: (a) computing a respective performance assessment for the series of interactions according to the method of claim 1, and (b) assigning a respective value to the series based on the respective performance assessment; and
exchanging contact details of the different users with a third party in return for transactions by the third party whose content is determined in response to the values assigned to the different users.

5. A computerized method for communication with real time bidding servers, the method comprising:
according to the method of claim 1, computing for each out of multiple series of interactions a performance assessment which is an assessment of an optional future conversion to which that series of interactions may lead; wherein each out of the multiple series includes at least one interaction which complies with a predefined criterion;
based on the computed performance assessments, updating a value assignment parameter; and
selectively initiating a communication of digital media which complies with the predefined criterion, wherein the selective initiation of the communication comprises bidding on an advertisement, wherein a magnitude of the bidding is based on the value assignment parameter.

6. A computerized method for inventory management, the method comprising:
according to the method of claim 1, computing for each out of multiple series of interactions a performance assessment which is an expected magnitude of an optional future transaction to which that series of interactions may lead; wherein each out of the multiple series includes at least one interaction which complies with a predefined criterion;
based on the computed performance assessments, determining an expected inventory of at least one item to be transacted in the optional future transactions; and
selectively initiating a communication of digital media which complies with the predefined criterion, based on the expected inventory.

7. The method according to claim 1, further comprising statistically analyzing the historical data of the plurality of series of interactions, and determining the assessment scheme based on a result of the analyzing.

8. The method according to claim 7, wherein the computing is based on properties relating to at least one interaction out of the series of interactions, wherein the statistical analysis is based on frequencies of patterns of interactions having said properties.

9. A computerized method for communication, the method comprising:
obtaining information pertaining to interactions which are included in an original series of user interactions, wherein at least one of the interactions of the original series comprises communication of digital media over a network connection;
based on the obtained information, defining multiple possible future interactions which may occur after the original series of interactions;
for each out of multiple hypothetical series of interactions, each of the multiple hypothetical series of interactions includes the original series and at least one of the multiple possible future interactions, computing a performance assessment according to the method of claim 1;
selecting one or more out of the possible future interactions based on the performance assessment computed for different hypothetical series; and
executing the selected possible future interactions.

10. The method according to claim 9, wherein the method is used for retargeting a selected user with an advertisement which is selected based on previous Internet interactions with the selected user, wherein the selecting comprises selecting an advertisement out of multiple possible advertisements, and wherein the executing comprises presenting the selected advertisement to the selected user.

11. The method according to claim 1, wherein the computing is based on properties relating to at least one interaction out of the series of interactions, wherein the properties comprise at least one property which is unrelated to a time in which any of the interactions occurred.

12. The method according to claim 11, wherein the properties comprise properties quantifying relative quality of the interactions.

13. The method according to claim 11, wherein the properties comprise types of communication channels used by the respective interactions.

14. The method according to claim 11, wherein the properties comprise properties of at least one subset of interactions of the series, wherein the subset includes multiple interactions.

15. The method according to claim 1, wherein the computing is based on a pattern occurring in at least one property of the interactions across the series of interactions.

16. A computerized prediction method for assessing an optional future conversion of a selected user based on a history of interactions with the selected user, the method comprising executing by a processor:
obtaining information pertaining to interactions with the selected user which are included in a series of user interactions associated with the selected user, wherein at least one of the interactions of the series comprises communication of digital media over a network connection; and
computing a conversion assessment for the series of interactions, based on the obtained information and on an assessment scheme which is based on a statistical analysis of historical data of a plurality of series of interactions;
wherein the conversion assessment pertains to the optional future conversion of the selected user which is valuable to an advertiser whose digital media was communicated to the selected user in at least one interaction of the series.

17. A system operable to computing a performance assessment, the system comprising:
an interface, configured to obtain information of interactions which are included in a series of interactions, wherein at least one of the interactions of the series comprises communication of digital media over a network connection; and
a processor on which a performance assessment module is implemented, the performance assessment module is configured to compute a performance assessment for the series of interactions, based on the obtained information and on an assessment scheme which is based on a statistical analysis of historical data of a plurality of series of interactions.

18. The system according to claim 17, comprising an assessment scheme processing module which is configured to statistically analyze the historical data of the plurality of series of interactions, and to determine the assessment scheme based on a result of the analyzing.

19. The system according to claim 18, wherein the performance assessment module is configured to compute the performance analysis based on properties relating to at least one interaction out of the series of interactions, wherein the statistical analysis of the assessment scheme processing module is based on frequencies of patterns of interactions having said properties.

20. The system according to claim 19, wherein the statistical analysis of the assessment scheme processing module is based on relative success of sets of interactions having certain patterns of interactions with respect to success of other sets of interactions having other patterns of interactions.

21. The system according to claim 17, wherein the performance assessment module is configured to compute the performance assessment based on properties relating to at least one interaction out of the series of interactions, wherein the properties comprise at least one property which is unrelated to a time in which any of the interactions occurred.

22. The system according to claim 21, wherein the properties comprise properties quantifying relative quality of the interactions.

23. The system according to claim 21, wherein the properties comprise types of communication channels used by the respective interactions.

24. The system according to claim 21, wherein the properties comprise properties of at least one subset of interactions of the series, wherein the subset includes multiple interactions.

25. The system according to claim 17, wherein the performance assessment module is configured to compute the performance assessment based on a pattern occurring in at least one property of the interactions across the series of interactions.

26. The system according to claim 17, wherein at least one out of the series of interactions is a conversion.

27. A program storage device readable by machine, tangibly embodying a program of instructions executable by the machine to perform a method which comprises the steps of:
obtaining information pertaining to interactions which are included in a series of user interactions, wherein at least one of the interactions of the series comprises communication of digital media over a network connection; and
computing a performance assessment for the series of interactions, based on the obtained information and on an assessment scheme which is based on a statistical analysis of historical data of a plurality of series of interactions.

28. A program storage device readable by machine, tangibly embodying a program of instructions executable by the machine to perform a prediction method for individual users based on user interactions history, the program of instructions comprising the instructions of the program of claim 27, wherein the series of user interactions is associated with a selected user, wherein at least one of the interactions of the series comprises communication of digital media over a network connection to the selected user; wherein the computing comprises: based on the obtained information with respect to the specific user and on the assessment scheme, computing the performance assessment for the series of interactions associated with the selected user; wherein the computing is based on properties relating to at least one interaction out of the series of interactions, wherein the properties comprise properties of at least one subset of interactions of the series, wherein the subset includes multiple interactions and at least one property out of the following types: (a) properties quantifying relative quality of the interactions, (b) types of communication channels used by the respective interactions.

29. The program storage device according to claim 27, further comprising assigning a value to the series based on the performance assessment.

30. A program storage device readable by machine, tangibly embodying a program of instructions executable by the machine to perform a prediction method for lead generation, the program of instructions comprising instructions for:
assigning different values to the different users associated with multiple respective series of interactions, by executing for each out of multiple series of interactions, each of the series being associated with a different user: (a) computing a respective performance assessment for the series of interactions according to the program of instructions of claim 27, and (b) assigning a respective value to the series based on the respective performance assessment; and
exchanging contact details of the different users with a third party in return for transactions by the third party whose content is determined in response to the values assigned to the different users.

31. A program storage device readable by machine, tangibly embodying a program of instructions executable by the machine to perform a method for communication with real time bidding servers, the program of instructions comprising instructions for:
according to the instructions of the program of claim 27, computing for each out of multiple series of interactions a performance assessment which is an assessment of an optional future conversion to which that series of interaction may lead; wherein each out of the multiple series includes at least one interaction which complies with a predefined criterion;
based on the computed performance assessments, updating a value assignment parameter; and
selectively initiating a communication of digital media which complies with the predefined criterion, wherein the selective initiation of the communication comprises bidding on an advertisement, wherein a magnitude of the bidding is based on the value assignment parameter.

32. A program storage device readable by machine, tangibly embodying a program of instructions executable by the machine to perform a method for inventory management, the program of instructions comprising instructions for:
according to the instructions of the program of claim 27, computing for each out of multiple series of interactions a performance assessment which is an expected magnitude of an optional future transaction to which that series of interaction may lead; wherein each out of the multiple series includes at least one interaction which complies with a predefined criterion;
based on the computed performance assessments, determining an expected inventory of at least one item to be transacted in the optional future transactions; and
selectively initiating a communication of digital media which complies with the predefined criterion, based on the expected inventory.

33. The program storage device according to claim 27, further comprising statistically analyzing the historical data of the plurality of series of interactions, and determining the assessment scheme based on a result of the analyzing.

34. The program storage device according to claim 33, wherein the computing is based on properties relating to at least one interaction out of the series of interactions, wherein the statistical analysis is based on frequencies of patterns of interactions having said properties.

35. A program storage device readable by machine, tangibly embodying a program of instructions executable by the machine to perform a method for communication, the program of instructions comprising instructions for:
obtaining information pertaining to interactions which are included in an original series of user interactions, wherein at least one of the interactions of the original series comprises communication of digital media over a network connection;
based on the obtained information, defining multiple possible future interactions which may occur after the original series of interactions;
for each out of multiple hypothetical series of interactions, each of the multiple hypothetical series of interactions includes the original series and at least one of the multiple possible future interactions, computing a performance assessment according to the instructions of the program of claim 27;
selecting one or more out of the possible future interactions based on the performance assessment computed for different hypothetical series; and
executing the selected possible future interactions.

36. The program storage device according to claim 35, tangibly embodying a program of instructions executable by the machine to perform a method for retargeting a selected user with an advertisement which is selected based on previous Internet interactions with the selected user, wherein the selecting comprises selecting an advertisement out of multiple possible advertisements, and wherein the executing comprises presenting the selected advertisement to the selected user.

37. The program storage device according to claim 27, wherein the computing is based on properties relating to at least one interaction out of the series of interactions, wherein the properties comprise at least one property which is unrelated to a time in which any of the interactions occurred.

38. The program storage device according to claim 35, wherein the properties comprise properties quantifying relative quality of the interactions.

39. The program storage device according to claim 35, wherein the properties comprise types of communication channels used by the respective interactions.

40. The program storage device according to claim 35, wherein the properties comprise properties of at least one subset of interactions of the series, wherein the subset includes multiple interactions.

41. The program storage device according to claim 27, wherein the computing is based on a pattern occurring in at least one property of the interactions across the series of interactions.

42. The method according to claim 1, wherein the method comprises computing an assessment of a time before a conversion of the series of interaction is reached, based on the obtained information and on the assessment scheme.

43. The method according to claim 42, wherein the series of interactions fulfill a selection condition; wherein the assessment scheme pertains only to series of interactions which fulfill the selection condition; wherein the statistical analysis is a statistical analysis of historical data of selected series of interactions, selected based on compliance of the selected series of interactions with at least one selection rule.

44. A computerized prediction method for individual users based on user interactions history, the method comprising executing the method of claim 42;
wherein the series of user interactions is associated with a selected user, wherein at least one of the interactions of the series comprises communication of digital media over a network connection to the selected user;
wherein the computing comprises: based on the obtained information with respect to the specific user and on the assessment scheme, computing the assessment of the time before the conversion of the series of interaction associated with the selected user is reached;
wherein the computing is based on properties relating to at least one interaction out of the series of interactions, wherein the properties comprise properties of at least one subset of interactions of the series, wherein the subset includes multiple interactions and at least one property out of the following types: (a) properties quantifying relative quality of the interactions, (b) types of communication channels used by the respective interactions.

45. The method according to claim 1, comprising multiple stages of computing of performance assessments, wherein the computing of the performance assessment is followed by computing of a second performance assessment for the series of interactions, based on the obtained information and on a second assessment scheme which is based on a second statistical analysis of historical data; wherein the second performance assessment is an assessment of a time before a conversion of the series of interaction is reached.

46. The method according to claim 45, wherein the computing of the second performance assessment is based on a result of the computing of the performance assessment.
